(19) United States
(12) Patent Application Publication
(10) Pub. No.: US 2025/0023059 A1
(43) Pub. Date: Jan. 16, 2025

(54) ELECTRODES COMPRISING LIQUID/GAS DIFFUSION LAYERS AND SYSTEMS AND METHODS FOR MAKING AND USING THE SAME

(71) Applicant: University of Tennessee Research Foundation, Knoxville, TN (US)

(72) Inventors: Feng Yuan Zhang, Tullahoma, TN (US); Lei Ding, Tullahoma, TN (US); Kui Li, Los Alamos, NM (US); Zhiqiang Xie, Tullahoma, TN (US); Weitian Wang, Tullahoma, TN (US); Shule Yu, Tullahoma, TN (US)

(73) Assignee: University of Tennessee Research Foundation, Knoxville, TN (US)

(21) Appl. No.: 18/684,264

(22) PCT Filed: Aug. 16, 2022
(86) PCT No.: PCT/US2022/040515

§ 371 Date: Feb. 16, 2024

Related U.S. Application Data
(63) Continuation-in-part of application No. 17/717,899, filed on Apr. 11, 2022.
(60) Provisional application No. 63/242,284, filed on Sep. 9, 2021.
(60) Provisional application No. 63/233,531, filed on Aug. 16, 2021.

(51) Int. Cl. H01M 4/88; C25B 11/032; H01M 4/92; H01M 8/0232; H01M 8/0245; H01M 8/10; H01M 8/1004

(52) U.S. Cl. CPC H01M 4/8807; C25B 11/032; H01M 4/8817; H01M 4/8853; H01M 4/92; H01M 4/923; H01M 8/0232; H01M 8/0245; H01M 8/1004; H01M 2008/1095

(57) ABSTRACT

The presently disclosed subject matter relates to devices, systems, and methods for fabricating a solid polymer electrolyte electrode assembly are provided. One or more electrode for a solid polymer electrolyte electrode assembly includes a porous substrate configured as a liquid/gas diffusion layer and an ionomer-free catalyst coated on the substrate.

### PRIORITY CLAIM

The present application claims the priority benefit of U.S. Patent Application Ser. No. 63/233,531, filed Aug. 16, 2021, and U.S. Patent Application Ser. No. 63/242,284, filed Sep. 9, 2021, and is a continuation-in-part of, and claims priority to, U.S. patent application Ser. No. 17/717,899, filed Apr. 11, 2022, the disclosures of which are incorporated herein by reference in their entireties.

### GOVERNMENT INTEREST

This invention was made with government support under Grant Nos. EE0008426 and EE0008423 awarded by the Department of Energy. The government has certain rights in the invention.

### TECHNICAL FIELD

The subject matter disclosed herein relates generally to electrolyzers, fuel cells, unitized regenerative fuel cells (URFCs), and other electrochemical cells. More particularly, the subject matter disclosed herein relates to the design and construction of membrane electrode assemblies of such devices.

### BACKGROUND

To avoid environmental issues in the production of hydrogen for energy use, water electrolysis has been emerged as a sustainable and clean technology to produce hydrogen with high purity in an eco-friendly way. To push the widespread application of electrolysis at large and small scales for hydrogen production, the solid polymer electrolyte electrolyzer such as proton exchange membrane electrolyzer cell (PEMEC) has emerged, which is an efficient way to achieve net-zero carbon emissions coupled with abundant and cheap renewable electricity. Compared to conventional water electrolyzer systems, the PEMEC shows many advantages such as high efficiency, compact design, quick startup, low maintenance cost, and close-to-zero emissions. Moreover, the generated hydrogen/oxygen in the PEMEC through renewable energy resources can be easily converted into power and water with the PEMFC system.

Nevertheless, the large-scale application of the PEMEC still suffers from several challenges: complicated and costly electrode preparation, limited resource and high cost of platinum group metal (PGM)-based materials, and undesired stability at high current densities. So far, a general electrode fabrication method is to spray a catalyst ink by mixing catalyst with NAFION™ ionomers onto the membrane to form a catalyst-coated membrane (CCM) with high catalyst loadings over 1 mg/cm². The high cost and scarcity of platinum-group metal catalysts still make it challenging to scale up for practical applications. In addition, during the electrode fabrication process, multiple steps and expensive equipment are involved, which is time-consuming, costly, and complicated. Additionally, the conventional CCM design suffers from undesired performance degradation because the involved NAFION™ ionomer in the catalyst layer is not stable, tends to degrade, and even causes catalysts to peel off during the cell operation. Therefore, it is highly desired to develop significantly simplified and low-cost electrode fabrication with high performance and long stability in practical application.

### SUMMARY

In accordance with this disclosure, devices, systems, and methods for fabricating an electrode assembly for solid- and liquid-electrolyte-based electrochemical devices are provided. In one aspect, an electrode for a solid or liquid electrolyte electrode assembly is provided. The electrode includes a substrate comprising one or more porous material layer and an ionomer-free catalyst coated on the substrate.

In another aspect, a solid polymer electrolyte electrode assembly includes a solid polymer electrolyte membrane, a liquid/gas diffusion layer arranged on one side of the solid polymer electrolyte membrane, and an ionomer-free catalyst coated on the liquid/gas diffusion layer.

In another aspect, a method for fabricating a solid polymer electrolyte electrode assembly includes providing a substrate comprising one or more porous material layer, coating an ionomer-free catalyst layer on the substrate, and coupling the catalyst-coated substrate to a solid polymer electrolyte membrane.

In another aspect, a dual electrode assembly for a solid polymer electrolyte device includes a solid polymer electrolyte membrane, a first substrate arranged on a first side of the solid polymer electrolyte membrane, a second substrate arranged on a second side of the solid polymer electrolyte membrane substantially opposing the first side, an ionomer-free anode catalyst coated on the first substrate, and an ionomer-free cathode catalyst coated on the second substrate.

Although some of the aspects of the subject matter disclosed herein have been stated hereinabove, and which are achieved in whole or in part by the presently disclosed subject matter, other aspects will become evident as the description proceeds when taken in connection with the accompanying drawings as best described hereinbelow.

### BRIEF DESCRIPTION OF THE DRAWINGS

The features and advantages of the presently disclosed subject matter will be more readily understood from the following detailed description which should be read in conjunction with the accompanying drawings that are given merely by way of explanatory and non-limiting example, and in which:

FIG. 1 is an exploded side perspective view of a membrane electrode assembly according to an embodiment of the presently disclosed subject matter.

FIGS. 2A and 2B are images showing a comparison between an un-modified thin/tunable liquid/gas diffusion layer and a similar structure to which a nitride surface modification has been applied according to an embodiment of the presently disclosed subject matter.

FIG. 2C is a series of images showing a surface composition analysis from an energy-dispersive X-ray spectroscopy (EDX) spectrum analysis for a nitride surface modified liquid/gas diffusion layer according to an embodiment of the presently disclosed subject matter.

FIG. 3A is a graph illustrating cell performance of thin/well-tunable liquid/gas diffusion layers (TTLGDLs) with and without a TiNₓ coating layer according to embodiments of the presently disclosed subject matter.

FIG. 3B is a graph illustrating high-frequency resistance (HFR) of thin/well-tunable liquid/gas diffusion layers (TTLGDLs) with and without a TiNₓ coating layer according to embodiments of the presently disclosed subject matter.

FIG. 4 is a graph illustrating plots of linear scan voltammetry (LSV) for oxygen evolution reaction (OER) performance test on iridium-based electrodes with and without TiNₓ coating layer according to embodiments of the presently disclosed subject matter.

FIG. 5A is a graph illustrating cell performance of iridium-based catalyst-coated LGDLs (Ir-CCLGDL) with and without TiNₓ coating layer according to embodiments of the presently disclosed subject matter.

FIG. 5B is a graph illustrating HFR of iridium-based catalyst-coated LGDLs (Ir-CCLGDL) with and without TiNₓ coating layer according to embodiments of the presently disclosed subject matter.

FIGS. 6A through 6E are scanning electron microscope (SEM) images of a surface of a titanium substrate that is modified by a hydrochloric acid treatment according to an embodiment of the presently disclosed subject matter.

FIG. 6F is a side view of a substrate surface treated by a hydrochloric acid treatment according to an embodiment of the presently disclosed subject matter.

FIGS. 7A through 7E are SEM images of a surface of a titanium substrate that is modified by an oxalic acid treatment according to an embodiment of the presently disclosed subject matter.

FIG. 7F is a side view of a substrate surface treated by an oxalic acid treatment according to an embodiment of the presently disclosed subject matter.

FIG. 8 is a side perspective view of a porous IrOₓ nanosheet (IrOₓ-NS) catalyst coated on a TTLGDL substrate according to an embodiment of the presently disclosed subject matter.

FIGS. 9A through 9G are images showing morphological and compositional characterizations of porous IrOₓ-NS CCLGDLs composed of porous iridium oxide nanosheets selectively grown on the single side of thin LGDL substrates according to an embodiment of the presently disclosed subject matter.

FIG. 10A is a graph illustrating the performance of cells using the IrOₓ-NS CCLGDL under high current densities according to an embodiment of the presently disclosed subject matter.

FIG. 10B is a graph showing the high-frequency resistance (HFR) plot of an IrOₓ-NS CCLGDL according to an embodiment of the presently disclosed subject matter.

FIG. 10C is a graph showing stability evaluation of an IrOₓ-NS CCLGDL according to an embodiment of the presently-disclosed subject matter.

FIGS. 11A and 11B are SEM images of a Pt-nanosheet (Pt-NS) catalyst-coated LGDL (CCLGDL) according to an embodiment of the presently disclosed subject matter.

FIG. 12A is a graph of cell performance of a Pt-NS CCLGDL according to an embodiment of the presently disclosed subject matter.

FIG. 12B is a graph showing the high-frequency resistance (HFR) plot of an Pt-NS CCLGDL according to an embodiment of the presently-disclosed subject matter.

FIGS. 13A through 13C are SEM images of Ir-nanosheets (Ir-NS) on titanium substrates according to an embodiment of the presently disclosed subject matter.

FIG. 13D is a series of SEM-EDX mapping images of Ir-nanosheets on titanium substrates according to an embodiment of the presently disclosed subject matter.

FIG. 14A is a graph of cell performance and HFR-free cell performance of an Ir-NS CCLGDL according to an embodiment of the presently disclosed subject matter.

FIG. 14B is a graph showing the high-frequency resistance (HFR) plot of an Ir-NS CCLGDL according to an embodiment of the presently disclosed subject matter.

FIG. 15 is a graph showing a cell stability test of an Ir-NS CCLGDL at 1.8 A/cm² according to an embodiment of the presently disclosed subject matter.

FIG. 16 is an SEM image of a modified IrOₓ catalyst layer uniformly deposited on the surface of the TTLGDL according to an embodiment of the presently disclosed subject matter.

FIG. 17A is a graph of cell performance of a modified IrOₓ CCLGDL according to an embodiment of the presently disclosed subject matter.

FIG. 17B is a graph of high-frequency resistance (HFR) plot of a modified IrOₓ CCLGDL according to an embodiment of the presently-disclosed subject matter.

FIG. 18 is a graph showing stability evaluation of a modified IrOₓ CCLGDL according to an embodiment of the presently disclosed subject matter.

FIGS. 19A and 19B are top view SEM images with different magnifications of a chemically synthesized bimetallic nanostructured IrRuOₓ (nanostructured IrRuOₓ) catalysts uniformly grown on the surface of a titanium substrate according to an embodiment of the presently disclosed subject matter.

FIGS. 20A through 20C are SEM and elemental mapping images of a bimetallic nanostructured IrRuOₓ catalyst on a titanium substrate, the iridium component, and the ruthenium component, respectively, according to an embodiment of the presently disclosed subject matter.

FIG. 20D is a graph showing an Energy-dispersive X-ray spectroscopy spectrum of a bimetallic nanostructured IrRuOₓ catalyst according to an embodiment of the presently disclosed subject matter.

FIG. 21 is a graph showing OER polarization curves of nanostructured IrRuOₓ, IrOₓNS and IrO₂ according to an embodiment of the presently disclosed subject matter.

FIG. 22 is a top view SEM image of a co-electroplated IrRuOₓ CCLGDL according to an embodiment of the presently disclosed subject matter.

FIGS. 23A through 23E are images of a SEM mapping area of a co-electroplated IrRuOₓ catalyst on a titanium substrate, an iridium component, a ruthenium component, an oxygen component, and a titanium component, respectively, according to an embodiment of the presently disclosed subject matter.

FIG. 24A is a graph showing cell performance and HFR-free cell performance of a co-electroplated IrRuOₓ CCLGDL according to an embodiment of the presently disclosed subject matter.

FIG. 24B is a graph of HFR of a co-electroplated IrRuOₓ CCLGDL according to an embodiment of the presently-disclosed subject matter.

FIG. 25 is a graph showing a stability evaluation of a co-electroplated IrRuOₓ CCLGDL according to an embodiment of the presently disclosed subject matter.

FIGS. 26A through 26E are a series of SEM and EDX mapping characterizations of a nanoengineered MoS₂NS/Ti electrode according to an embodiment of the presently disclosed subject matter.

FIG. 27A is an SEM image of a carbon fiber paper (CFP) substrate.

FIGS. 27B through 27D are SEM images of nanoengineered MoS₂NS/CFP according to an embodiment of the presently disclosed subject matter.

FIGS. 27E and 27F are SEM-EDX mapping images of a sulfur component and molybdenum component, respectively, of the nanoengineered MoS₂NS/CFP according to an embodiment of the presently disclosed subject matter.

FIGS. 28A through 28F are a series of HAADF-STEM images of nanoengineered MoS₂NS/CFP according to an embodiment of the presently disclosed subject matter.

FIGS. 29A through 29D are high-resolution XPS spectra of nanoengineered MoS₂NS/CFP according to an embodiment of the presently disclosed subject matter.

FIGS. 30A and 30B are graphs showing comparisons of cell performances of a nanoengineered MoS₂NS/CFP electrode according to an embodiment of the presently disclosed subject matter relative to a conventional MoS₂NS/CFP electrode and other previously reported MoS₂-based electrodes.

FIG. 31A is a graph showing HFR-free cell performances of a nanoengineered MoS₂NS/CFP electrode according to an embodiment of the presently disclosed subject matter relative to a conventional MoS₂NS/CFP electrode.

FIG. 31B is a graph showing a mass activity comparison of a nanoengineered MoS₂NS/CFP electrode according to an embodiment of the presently disclosed subject matter relative to a conventional MoS₂NS/CFP electrode.

FIGS. 32A and 32B are SEM images of modified IrOₓ CCLGDL as anode and Pt-NS CCLGDL as cathode, respectively, according to an embodiment of the presently disclosed subject matter.

FIG. 33A is a graph showing cell performance and HFR-free cell performance of a dual CCLGDL MEA according to an embodiment of the presently disclosed subject matter.

FIG. 33B is a graph showing a stability evaluation of a dual CCLGDL MEA according to an embodiment of the presently disclosed subject matter.

FIG. 33C is a graph of high-frequency resistance (HFR) plot of a dual CCLGDL MEA according to an embodiment of the presently disclosed subject matter.

### DETAILED DESCRIPTION

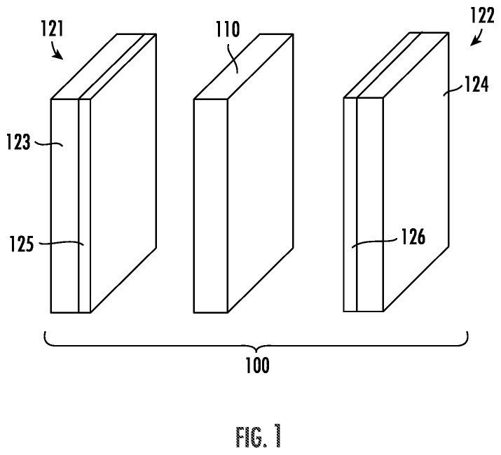

The presently disclosed subject matter provides devices, systems, and methods for producing membrane electrode assemblies for solid or liquid electrolyte electrolyzers, fuel cells, unitized regenerative fuel cells, and other electrochemical cells. In one aspect, the presently disclosed subject matter provides a gas diffusion electrode that is formed by directly coating ionomer-free catalysts on substrates with low catalyst loadings. Referring to FIG. 1, in some embodiments, a membrane electrode assembly, generally designated 100, includes a solid polymer electrolyte membrane 110, a first catalyst-coated liquid/gas diffusion layer (first CCLGDL) 121 arranged on a first side of the solid polymer electrolyte membrane 110, and a second catalyst-coated liquid/gas diffusion layer (second CCLGDL) 122 arranged on a second side of the solid polymer electrolyte membrane 110 substantially opposing the first side, where the first CCLGDL 121 includes a first liquid/gas diffusion layer (first LGDL) 123 on which a first catalyst coating 125 is formed and/or the second CCLGDL 122 includes a second liquid/gas diffusion layer (second LGDL) 124 on which a second catalyst coating 126 is formed.

For PEM water electrolysis and other electrochemical device applications, the solid polymer electrolyte membrane 110 can be configured as a solid polymer electrolyte (SPE) type 1. In some such embodiments, the solid polymer electrolyte membrane 110 can be selected from any of a variety of polyfluorosulfonic acid materials, such as NAFION™ membranes with thickness in a range from about 20 μm to 250 μm. For example, in addition to NAFION™ 117 (e.g., having a thickness of about 175 um), other NAFION™ membranes with different thicknesses can also be used, including but not limited to NAFION™ 115 (e.g., having a thickness of about 125 μm), NAFION™ 212 (e.g., having a thickness of about 50 μm), NAFION™ 211 (e.g., having a thickness of about 25 μm), NAFION™ HP (e.g., having a thickness of about 20 μm), or NAFION™ 1110 (e.g., having a thickness of about 250 μm). For a solid polymer electrolyte (SPE) type 2 configuration, the solid polymer electrolyte membrane 110 can be an Aquivion® based membrane (e.g., with a thickness in a range from about 20 μm to about 100 μm). For a solid polymer electrolyte (SPE) type 3 configuration, the solid polymer electrolyte membrane 110 can be formed from polybenzimidazoles, poly ether sulfones (PES), poly ether ketones (PEEK), or sulfonated polyphenyl quinoxaline (SPPQ). For AEM water electrolysis and other electrochemical device applications, the solid polymer electrolyte membrane 110 can include, but is not limited to, a poly(fluorenyl-co-aryl piperidinium) (PFAP)-based anion exchange material, a hexamethyl trimethyl ammonium-functionalized Diels-Alder polyphenylene (HTMA-DAPP) membrane material, commercial membranes under the tradename Sustainion®X37-50, FAA-3-30, FAA-3-50, FAA-3-PK-75, A201, Pure material m-TPN1, and other newly developed membranes with modified different cationic functional groups including cyclic or spirocyclic QA, imidazolium, guanidinium, pyridinium and quaternary phosphonium (QP). A representative thickness range of these AEMs is from about 20 μm to about 200 μm.

In other embodiments, the electrode assemblies disclosed herein can be used in liquid electrolyte systems. For example, when a liquid electrolyte of 0.5M H₂SO₄ is applied, various anode electrodes including electroplated Ir-CCLGDL and Ir-CCLGDL-TiN, chemically-synthesized IrOₓNS and nanostructured IrRuOₓ can display excellent catalytic performances in oxygen evolution reaction (OER) application. The liquid electrolytes (e.g., H₂SO₄, KOH, NaOH, etc.) with a representative concentration range of about 0.1 M˜1 M can be employed for various electrochemical device applications such as acidic or alkaline water electrolyzers, fuel cells, CO₂/N₂ electrolyzers and so forth. Those having ordinary skill in the art will thus recognize that the catalyst layer technologies disclosed herein can be applied in many configurations to both solid-and liquid-electrolyte-based electrochemical devices.

For conventional solid polymer electrolyte electrolyzer applications, a large portion of catalysts for the conventional catalyst-coated membrane (CCM) is underutilized and results in a low catalyst utilization. To address this issue, in some embodiments, one or both electrode of the membrane electrode assembly 100 includes a substrate comprising one or more porous material layer that is configured to serve as the first or second LGDL 123 or 124, respectively, and an ionomer-free catalyst coated on the substrate. In some embodiments, the substrate can further include one or more nonporous material layer. For instance, one or more porous material layer can combine with one or more nonporous material layer to form a composite substrate. In some embodiments, one or more nonporous material layer can function as a current distributor in a device. In some embodiments, one or more nonporous material layer can work with one or more porous layer together to build up flow channels for reactant/product transport during the device operation. In some embodiments, one or more nonporous material layer can be modified with in-plane channels for further enhancing the reactant/product transport. Any metal-made or carbon-made or composite materials can be employed as the nonporous material layer, including but not limited to metal-based (e.g., titanium, nickel, stainless steel, niobium) or carbon-based or composite materials (e.g., carbon-lead (Pb), titanium-polyamide, graphite-phenolic resin, graphene-polylactic acid, carbon-silicon carbide, Metal based matrix composites, Titanium matrix composites (TMCs), Nickel matrix composites, etc.). In some embodiments, advanced manufacturing technologies are used to design and manufacture the substrate with one or more nonporous material layer and one or more porous material layer, in which the porous material layer includes gradient or non-gradient pore sizes and porosities or combinations thereof.

When combined with the solid polymer electrolyte membrane 110 (e.g., a proton exchange membrane or anion exchange membrane), the membrane electrode assembly 100 is formed from the combined catalyst-coated liquid/gas diffusion layer and solid polymer electrolyte membrane (CCLGDL/SPE), which can be obtained through a significantly simplified process compared to the design of conventional catalyst-coated membrane/liquid/gas diffusion layers (CCM/LGDL), which tend to be complex and include multiple fabrication steps.

In this configuration, the design and configuration of the first and second LGDLs 123 and 124 are important for the electron and heat conductivity and mass transport at the reaction sites. In contrast to conventional LGDLs (e.g. titanium felt, titanium foam, carbon fiber paper, carbon fiber cloth, and titanium mesh), which tend to have random structures and large thicknesses (e.g., greater than about 200 μm), in some embodiments, the presently-disclosed subject matter provides that one or both of the first or second LGDL 123 or 124 are configured as a thin/well-tunable LGDL (TTLGDL) that can exhibit well-controlled pore structures and much thinner thickness (e.g., ranging from about 25 μm to about 200 μm) by using advanced manufacturing technologies. In some embodiments, for example, one or both of the first or second LGDL 123 or 124 are made by first using a lithography technique to design different patterns on titanium or other substrates. Afterwards, via chemical wet etching, the TTLGDLs with controllable thicknesses, pore shapes, pore sizes, and porosities can be manufactured. The TTLGDLs have controllable pore sizes (e.g., ranging from about 20 to about 400 μm in hydraulic diameter, including about 20, 50, 100, 150, 200, 250, 300, 350, or 400 μm), pore shapes (e.g., circular, triangular, square, pentagonal, hexagonal, octagonal, decagonal, and other polygonal shapes or combinations thereof), and porosities (e.g., ranging from about 20% to about 70%, including about 20, 25, 30, 35, 40, 45, 50, 55, 60, 65, or 70%), and the thicknesses of employed substrates being variable (e.g., ranging from about 25 μm to about 200 μm, including about 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195 and 200 μm). Alternatively, in some embodiments, additive manufacturing technologies are used to design and manufacture the TTLGDLs with selected pore shapes, pore sizes, and porosities. In some alternative embodiments, expanded metal manufacturing technologies using a pressured slitting and stretching process can manufacture titanium or other substrates with different mesh patterns, pore sizes and thicknesses. In some further alternative embodiments, laser machining/cutting can precisely manufacture titanium or other substrates with controllable thicknesses, pore shapes, pore sizes, and porosities.

Regardless of the particular process by which the TTLGDLs are produced, in some embodiments, such a configuration can decrease the material cost and also decrease the ohmic and transport losses to achieve superior performances. Additionally, compared to the conventional LGDLs, the first or second LGDL 123 or 124 with well-controlled pore structures show planar surfaces, which can decrease the large interfacial contact resistances caused by random pore structures and rough surfaces. Such configurations can be applied in wide range of electrochemical reactions, such as for a hydrogen evolution reaction (HER) and oxygen evolution reaction (OER) in water electrolyzers, or for a hydrogen oxidation reaction (HOR) and oxygen reduction reaction (ORR) in fuel cells, URFCs and other electrochemical devices. In addition, they are chemically and structurally stable and can withstand various harsh corrosive conditions, such as high potential, acidic/alkaline environments.

### LGDL Surface Preparation

In some embodiments, the substrate of the first or second LGDL 123 or 124 can be modified to more readily receive the first or second catalyst coating 125 or 126, respectively, for improving the catalyst utilization. Specifically, for example, the surface of the substrate can be treated to improve adhesion and uniformity of the catalyst coating, which can lead to enhanced structural stability and performance.

### Surface Coating

In some embodiments, modification of the substrate can involve the addition of a surface coating, including but not limited to metals, nitrides, carbides, composites, or combinations thereof. In particular, in some embodiments modification of the substrate can involve nitridation on the substrate for nitride formation, which can be used to meet requirements of corrosion resistance that are sufficient to withstand the chemical and electrochemical corrosions from acidic/basic atmosphere and high voltage during cell operation, respectively. In some particular embodiments, for example, where a titanium-based substrate is used as the first or second LGDL 123 or 124, modification of the substrate can involve nitridation on the titanium substrate for titanium nitride (TiNₓ) formation, where x is a value in a range of 0<x≤5.0. For example, x can be 0.3, 0.5, 2, 5, or any other value falling within this range, depending on the nitridation levels. In some embodiments, such a nitridation process is carried out under ammonia at any of a range of temperatures from about 600° C. to about 1200° C., including 600° C., 700° C., 800° C., 900° C., or 1,000° C., 1,100° C., 1,200° C. The coating thickness can be dependent on the nitridation temperature and time, where a higher applied temperature can result in a thicker coating. In some embodiments, modifying these process parameters can result in coating thicknesses in a range of about 20 nm to about 200 nm. For example, at 800° C., the TiNₓ coating thickness can be about 120 nm, which is sufficient to increase the electrical conductivity. Moreover, TiNₓ can provide further benefits of high electrical conductivity and excellent inertia to most chemicals, and is reported as an effective electronic structure modulator, which meets the expectations for a promising substrate for catalysts used on an anode structure to facilitate the oxygen evolution reaction (OER). Therefore, even with a low catalyst loading, the TiNₓ coating can improve the catalyst activity in a lower overpotential for OERs.

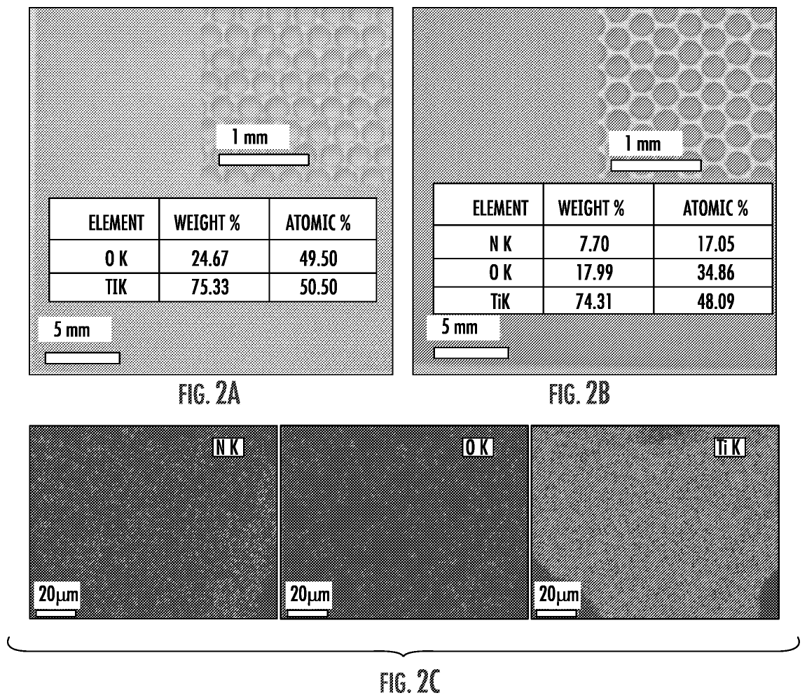

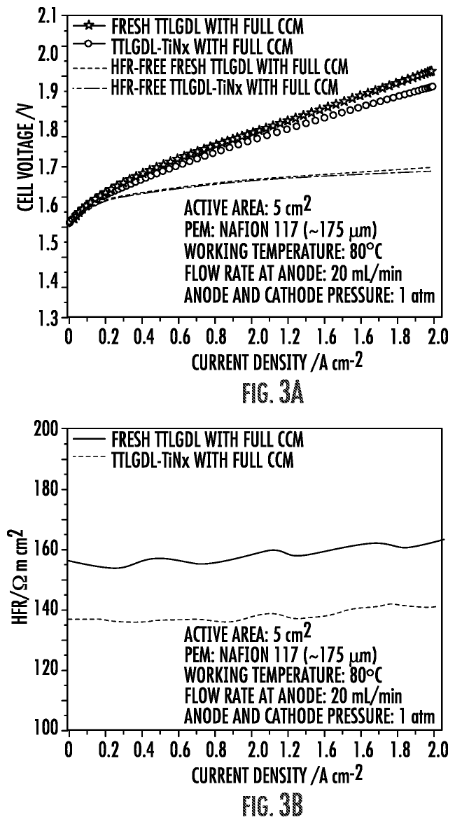

In one example embodiment, one or both of the first or second LGDL 123 or 124 is a thin/well-tunable liquid/gas diffusion layer (TTLGDL) that is fabricated from thin titanium foils with engineered thickness (e.g., ranging from about 25 to about 200 μm, including about 25, 30, 35, 40, 45, 50, 55, 60, 65, 70, 75, 80, 85, 90, 95, 100, 125, 150, 175, or 200 μm), pore shape (e.g., circular, triangular, square, pentagonal, hexagonal, octagonal, decagonal, and other polygonal shapes or combinations thereof), pore size (e.g., having a hydraulic diameter ranging from about 25 μm to about 400 μm, including about 25, 50, 100, 150, 200, 250, 300, 350, or 400 μm), and porosity (e.g., ranging from about 20% to about 70%, including about 20, 30, 35, 40, 45, 50, 55, 60, 65, or 70%). As shown in FIGS. 2A and 2B, it can be observed that a sample color change from a silvery white color into a golden yellow color indicates the formation of TiNₓ on the surface. The element mapping from energy-dispersive X-ray spectroscopy (EDX) spectrum analysis as shown in FIG. 2C indicates that the formed nitrides are uniformly distributed on the substrate surface as a result of the nitridation process. FIG. 3A shows a comparison of the performance between TiNₓ-coated TTLGDL and un-modified TTLGDL in the water electrolyzer cells coupled with full CCMs. All displayed cell performances disclosed herein were tested at the same working temperature of 80° C. and water flow rate of 20 mL/min at anode. The TTLGDL-TiNₓ can achieve 52-mV improved at 2 A/cm². FIG. 3B shows the average high-frequency resistance (HFR) of the cell with the TiNₓ-coated TTLGDL is 135 mΩ cm², which is ˜22 mΩ cm² lower than the one of the un-modified TTLGDL. The significant enhancement of TiNₓ-coated TTLGDL can be ascribed to the benefit that the low electrical resistance of the LGDL through the surface nitriding and/or oxide removal, such by using an oxalic acid treatment as discussed below.

In addition, in some embodiments, as compared to a catalyst-coated LGDL (CCLGDL) prepared from un-modified TTLGDLs, a TiNₓ-coated TTLGDL can provide particular benefits where the selected catalyst is iridium-based. First, the coated TiNₓ can reduce the kinetic overpotential of iridium-based catalysts for OERs. In particular, for example, as shown in FIG. 4, in a 0.5 M H₂SO₄ electrolyte at room temperature and a scan rate of 5 mV/s, an electrode configuration having an iridium-catalyst-coated LGDL (CCLGDL) with a modified TiNₓ surface composition (the preparation of which is discussed below in detail) shows 290 mV achieving a current density of 10 mA cm², which is 17 mV lower than that produced by a configuration of IrOₓ-CCLGDL. Second, an electrode prepared from TTLGDL-TiNₓ can reduce the ohmic resistance and improve the mass transport as compared to conventional configurations with random and thick structures. Third, through facile nitriding, a TiNₓ-coated substrate can be obtained, and this method is also easy to implement for industrial applications. Fourth, a configuration of Ir-CCLGDL-TiNₓ with a low catalyst loading (e.g., ranging from about 0.005 mg/cm² to about 0.35 mg/cm², including about 0.005, 0.01, 0.02, 0.05, 0.1, 0.15, 0.20, 0.25, 0,30, or 0.35 mg/cm²) can demonstrate enhanced cell performances. That being said, as also discussed herein above, those having ordinary skill in the art will recognize that the loading can be lowered to about 0.005 mg/cm² or increased to about 3.0 mg/cm² or more, depending on various application scenarios.

By way of elaboration and not limitation, in some embodiments, the presently disclosed subject matter provides a loading range of about 0.005 to about 3.0 mg/cm², including about 0.02 to about 3.0 mg/cm². In accordance with the presently disclosed subject matter, the catalyst layer technologies disclosed herein can achieve a good control of catalyst loadings from 0.005 to 3.0 mg/cm². Second, in accordance with the presently disclosed subject matter, it is demonstrated that the catalysts with the low catalyst loading range of 0.02 to 0.35 mg/cm² (including about 0.02, 0.05, 0.1, 0.15, 0.20, 0.25, 0,30, or 0.35 mg/cm²) can achieve good cell performance. However, the loading can be lowered down to as low as 0.005 mg/cm² or increase up to 3.0 mg/cm² or above, depending on a given application scenario. In some embodiments, after a certain point, loading more catalyst has diminishing gains in performance. Thus, in some embodiments, the catalyst comprises an active metal loading on the anode side of a substrate of no greater than about 1 mg/cm² (including about 0.01, 0.02, 0.05, 0.1, 0.15, 0.20, 0.25, 0,30, 0.35, 0.50, 0.75, or 1 mg/cm²) and on the cathode side of a substrate no greater than about 0.15 mg/cm² (including about 0.01, 0.02, 0.05, 0.1, or 0.15 mg/cm²).

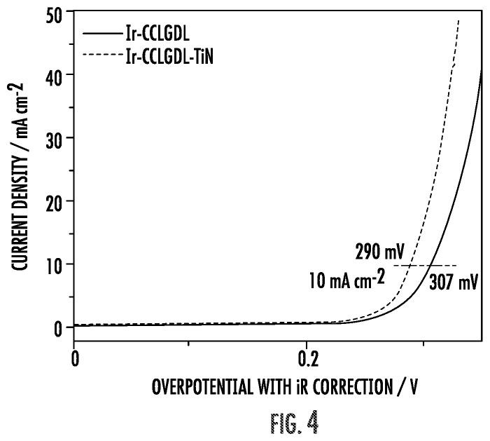

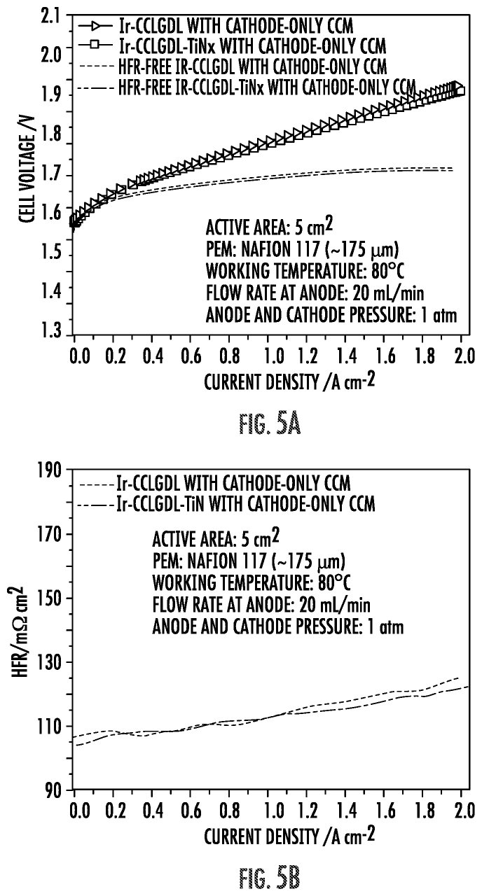

As coupled with a NAFION™117 membrane (used as a representative, non-limiting example), FIG. 5A shows that the Ir-CCLGDL-TiNₓ electrode exhibits a low cell voltage of 1.865 V demonstrated at 2 A/cm², which is 17-mV-enhanced compared to a Ir-CCLGDL electrode. FIG. 5B shows that the Ir-CCLGDL-TiNₓ electrode and Ir-CCLGDL electrode have the similar average HFR values of about 110 mΩ cm². For HFR-free performance, a low cell voltage of 1.62 V with Ir-CCLGDL-TiNₓ is demonstrated at the current density of 2 A/cm², which is 11-mV lower than a Ir-CCLGDL electrode. More broadly, the overall cell performance can be improved by about 10-20 mV compared to the CCLGDL without TiNₓ coating.

In another embodiment, the TiNₓ coating method and electrode integration design disclosed herein can also be applicable to various titanium-made LGDLs such as sintered fiber felts, meshes, and foams. Additionally, the TiNₓ coating method can be broadly applied to treat various LGDLs for reducing the electrical resistance in electrolyzer cells, fuel cells, unitized regenerative fuel cells, or other devices. Moreover, the as-coated TiNₓ can also be applied to other iridium-based catalysts or other non-iridium-based electrocatalysts for prompting the OER performance in the SPE systems. Further, in addition to improving the electronic conductivity of catalyst support for enhancing catalytic activities, the TiNₓ can also optimize the electronic structure of most catalysts.

Thus, in some embodiments, an electrode comprises a substrate comprising one or more titanium-made liquid/gas diffusion layer having a titanium nitride surface coating is disclosed. However, any other metal-made or carbon-made liquid/gas diffusion layer as would be apparent to one of ordinary skill in the art upon a review of the instant disclosure can be employed by adapting techniques as disclosed herein or as would be apparent to one of ordinary skill in the art upon a review of the instant disclosure. In some example embodiments, a nitride coating can be applied using the nitridation process disclosed above or by using any of a variety of other techniques, including but not limited to thermo-reactive deposition and diffusion (TRD), chemical vapor deposition (CVD), physical vapor deposition (PVD), electrochemical nitridation, pulsed laser deposition (PLD), plasma nitridation, sol-gel processes, or ion-beam-assisted deposition (IBAD). In some embodiments, a metal coating can be applied using any of a variety of techniques, including but not limited to sputtering or electroplating. In some embodiments, a carbide coating or composite coating can be applied using any of a variety of techniques, including but not limited to chemical vapor deposition (CVD), thermo-reactive deposition and diffusion (TRD), or co-sputtering. Representative metal-made or carbon-made liquid/gas diffusion layer materials include but are not limited to metal-based or carbon-based or composite patterned porous sheets (e.g., TTLGDLs, perforated sheets or expanded sheets), papers, felts, cloths, powders, foams, expanded meshes, and woven meshes. Representative metals include but are not limited to titanium, nickel, stainless steel, and niobium.

### Hydrochloric Acid Treatment

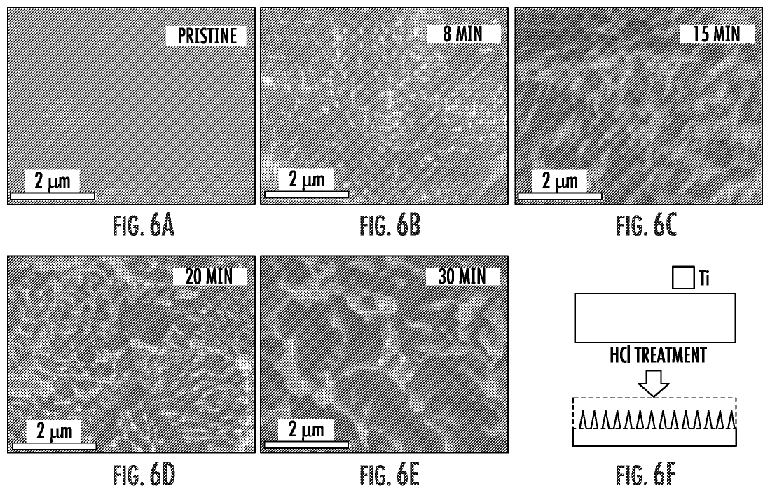

Alternatively, modification of the substrate can involve a direct acid treatment that provides a pure titanium surface and engineered structures at the same time, and thereby a surface with good conductivity and a large specific area can be achieved. Specifically, for example, in some embodiments, pillar structures can be generated and evolved by a hydrochloric acid (HCl) treatment to the surface of the substrate. In an example embodiment, a 37% w/w hydrochloric acid aqueous solution (HCl 36.5-38%) was sealed in a beaker and water bathed to 54° C. Based on experimental results, desired pillar surface structures can likewise be achieved using temperatures in a range from about 50° C. to about 54° C. and an HCl concentration in a range from about 30% w/w to about 37% w/w. Cropped titanium foil pieces were first cleaned through acetone, methanol, and DI water sonication (10 mins per step), and the cleaned titanium foils were put in the acid solution and sealed in the water bathed beaker. The treatment was executed in a functioning fume hood for different etching times, with etching intervals ranging from 8 minutes to 30 minutes or more, including, 8, 9, 10, 15, 20, 25, or 30 minutes, or more. The surface morphologies of HCl-treated titanium foils over time are shown in FIGS. 6A through 6E. Without acid treatment, a titanium foil displays a typical smooth surface with some manufacturing defects such as cracks and pits (FIG. 6A), but during the course of treatment, pillars with irregular shapes can be formed on the titanium surface (FIG. 6B), and denser and longer pillars can be evolved with additional time (FIG. 6C). However, extending the treatment further can result in the as-formed pillars becoming distributed sparsely and much shorter as the HCl starts to attack and etch off the developed pillars (FIGS. 6D and 6E). The etching rate of HCl treatment differs locally over the substrate, which is the mechanism by which the pillars occur. The calculated average etching rate of HCl treatment is about 200 nm per minute based on the weight loss and the wetting area of the sample. That being said, for HCl treatment, when the treatment temperature range is from 20 to 54° C., the etching rate can be in a range from about 50 nm/min to about 200 nm/min. In general, a higher temperature gives rise to a higher etching rate.

By achieving a surface with a large specific area, a HCl treatment with an etching time range from 10 min to 20 min can provide a desirable pillar-structured surface shown generally in FIG. 6F, with pillars having heights ranging from about 0.5 μm to about 2 μm. As seen from the SEM images in FIGS. 6A through 6E, the etching time significantly affects the final surface. Specifically, without the acid treatment, a titanium substrate displays a typical smooth surface with some manufacturing defects such as cracks and pits. With 8-min HCl treatment, pillars with irregular shapes were formed on the titanium surface. As the treatment duration increased to 15 min, denser and longer pillars were evolved. However, when 20-min treatment was applied, the as-formed pillars were distributed sparsely and much shorter than the titanium surface with 15-min HCl treatment, since HCl started to attack and etch off the developed pillars. Finally, as the etching proceeded longer to 30 min, an even sparser distribution of the pillars would appear. In addition, a higher temperature and a higher HCl concentration gives rise to a higher etching rate, and then would result in different final surfaces (e.g., different pillar heights and number of formed pillars).

After etching, the surface-treated samples were carefully cleaned by washing in DI water and ethanol, followed by drying in air at room temperature. Such pillar-structured substrate surface improves the surface area of electrodeposited iridium catalyst layers and lower interfacial contact resistances (ICR) compared to an un-modified titanium substrate surface.

### Oxalic Acid Treatment

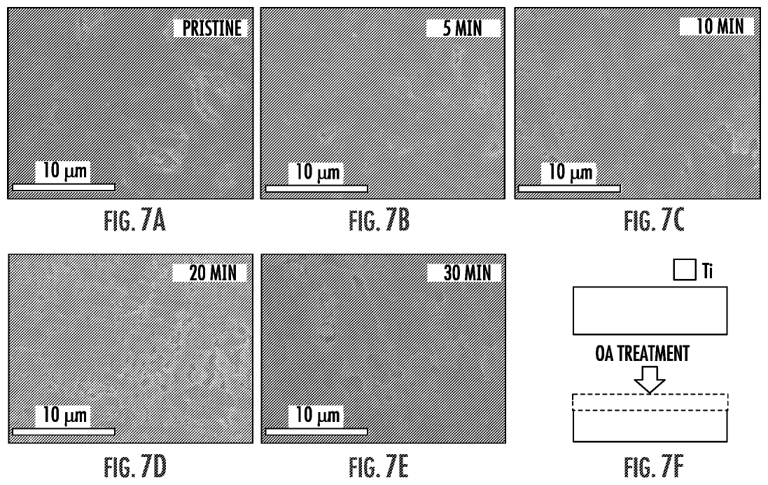

In yet a further alternative, in some embodiments, compared to the pillar structure from HCl treatment, an oxalic acid (OA) treatment can be used to provide a generally flat surface for the substrate. FIGS. 7A through 7E show SEM images of titanium substrates that are treated with oxalic acid (OA). In an example embodiment, cropped titanium foil pieces (e.g. about 2.5 cm×2.5 cm) were firstly cleaned by sonication with acetone, DI water, and ethanol, respectively (10 mins per step). A solution of OA (C₂H₂O₄·2H₂O, crystalline 99.5%˜102.5%) can be dissolved in DI water to prepare an aqueous solution for surface treatment that has an OA concentration in a range from about 0.1 N to about 1.0 N (e.g., including concentrations of 0.1, 0.2, 0.3, 0.4, 0.5, 0.6, 0.7, 0.8, 0.9, or 1.0 N). In general, under the same solution temperature and etching time, a higher OA concentration of 1.0 N can be expected to give rise to a higher etching rate of titanium substrates than that of 0.1 N OA aqueous solution. The OA solution was first heated (e.g., to a temperature in a range from about 70° C. to about 95° C., including about 70, 75, 80, 85, or 90° C.) with a water bath. Then, the titanium foil pieces were soaked in the solution and treated (e.g., at a temperature in a range from about 70° C. to about 95° C.) for different etching times. Comparing to the un-modified surface (FIG. 7A), the titanium surfaces were not heavily etched with 5-min OA treatment (FIG. 7B), but the etching slightly expands the cracks on the surface during the course of the treatment (FIG. 7C), progressively increasing the roughness of the titanium substrate, and the expansion of the cracks on the surface further proceeded as well as creating small damps on the surface (FIGS. 7D and 7E). As illustrated in FIG. 7F, the overall etching rate of OA treatment is uniform, and the calculated etching rate of OA treatment is about 50 nm per minute. In general, however, for OA treatment, when the treatment temperature is in a range from about 70° C. to about 95° C., the etching rate is in a range from about 25 nm/min to about 75 nm/min, where a higher temperature can give rise to a higher etching rate. The etching rate of OA treatment is much smaller than HCl treatment, which may enable the titanium surface to be etched more uniformly than when applying HCl treatment. Consequently, with the OA treatment from 5 to 30 min, titanium substrates still remained relatively smooth surfaces compared to an un-modified titanium substrate. In contrast to the surface treatment with HCl treatment, the surface morphologies of samples after iridium electrodeposition with 30-min OA treated substrates were more of nanoparticles stacking on a flat surface, which can likewise lower interfacial contact resistances compared to an un-modified titanium substrate surface. In some embodiments, the surface modification can further include coating a gold or platinum nanolayer (e.g., about 50 nm˜200 nm) on one side or both sides as a protective layer.

### Catalyst Composition and Formation

Regardless of the particular composition and/or configuration of the porous substrate serving as one or both of the first or second LGDL 123 or 124, improved catalyst utilization can be achieved by applying an ionomer-free catalyst as the first and/or second catalyst coating 125 or 126. For instance, in some embodiments, electrodes with low catalyst loading can provide competitive performance when prepared by engineering the catalyst layer with nano-featured structures. In some embodiments, catalysts with a catalyst loading in a range of about 0.02 mg/cm² to about 0.35 mg/cm² can achieve good cell performance. That being said, as also discussed herein above, those having ordinary skill in the art will recognize that the loading can be lowered to about 0.005 mg/cm² or increased to about 3.0 mg/cm² or more, depending on various application scenarios. For example, an appropriate catalyst loading can be adjusted based on the catalyst composition (e.g., precious or non-precious catalysts), and/or the device type into which the electrode is integrated (e.g., PEM electrolyzer, fuel cell, AEM electrolyzer, or CO₂/N₂ electrolyzer).

By way of elaboration and not limitation, in some embodiments, the presently disclosed subject matter provides a loading range of about 0.005 to about 3.0 mg/cm², including about 0.02 to about 3.0 mg/cm². In accordance with the presently disclosed subject matter, the catalyst layer technologies disclosed herein can achieve a good control of catalyst loadings from 0.005 to 3.0 mg/cm². Second, in accordance with the presently disclosed subject matter, it is demonstrated that the catalysts with the low catalyst loading range of 0.02 to 0.35 mg/cm² (including about 0.02, 0.05, 0.1, 0.15, 0.20, 0.25, 0,30, or 0.35 mg/cm²) can achieve good cell performance. However, the loading can be lowered down to as low as 0.005 mg/cm² or increase up to 3.0 mg/cm² or above, depending on a given application scenario. In some embodiments, after a certain point loading more catalyst has diminishing gains in performance. Thus, in some embodiments, the catalyst comprises an active metal loading on the anode side of a substrate of no greater than about 1 mg/cm² (including about 0.01, 0.02, 0.05, 0.1, 0.15, 0.20, 0.25, 0,30, 0.35, 0.50, 0.75, or 1 mg/cm²) and on the cathode side of a substrate no greater than about 0.15 mg/cm² (including about 0.01, 0.02, 0.05, 0.1, or 0.15 mg/cm²).

Compared with conventional dense and solid catalyst layers, the nano-featured catalyst layer can not only offer a large surface area exposing rich active sites for the electrochemical reactions and show the possibility to create abundant defects but also promote mass transport and thus decrease the mass transport loss in an electrochemical device. In some embodiments, the catalysts are directly modified on the LGDL without ionomer addition, which can avoid the conductivity and stability issues from the ionomer. In addition, in some embodiments, the catalyst layers can be directly coated on the LGDLs to form an electrode without requiring any carbon nanostructures or non-carbon materials as base or support materials on the LGDLs. In some embodiments, then, the electrode is free of any carbon nanostructure and/or is free of non-carbon materials as base or support materials on the LGDLs. Hence, cost-effective and high-efficiency electrolyzers to generate hydrogen can be achieved, promoting the large-scale industrial application of the electrolyzers.

### Iridium Oxide-Nanosheet-Coated Electrodes

In some embodiments, the ionomer-free catalyst comprises porous iridium oxide nanosheets (IrOₓ-NS) that are selectively grown on the liquid/gas diffusion layer, which can produce abundant exposed edges. In some embodiments, the liquid/gas diffusion layer can comprise one or more thin titanium layer with tunable thicknesses (e.g., from about 25 μm to about 200 μm, including about 25, 30, 35, 40, 45, 50, 55, 60, 65, 70, 75, 80, 85, 90, 95, 100, 125, 150, 175, or 200 μm). In some embodiments, the electrode production can further include post-washing (e.g., with acetone and ethanol), and the porous IrOₓ-NS CCLGDL can be annealed. The annealing can be performed at a temperature in a range of about 150° C. to about 450° C., including about 150, 175, 200, 225, 250, 275, 300, 325, 350, 375, 400, 425 or 450° C., for a time period ranging from about 5 min to about 60 min, including 5, 10, 15, 20, 25, 30, 35, 40, 45, 50, 55, or 60 min. The annealing can be conducted in vacuum or under inert gas atmospheres (e.g., Ar, N₂) to produce the finished electrode.

An electrode that is produced with such a nanoengineered porous IrOₓ-NS CCLGDL can provide a number of advantages. In some embodiments, such an electrode can minimize ohmic and mass transport losses as compared to conventional CCM-based MEAs. Further, in some embodiments, the nanoporous iridium catalyst layer without ionomer addition can provide abundant reaction sites for electrochemical reactions and significantly reduce the reaction overpotentials or activation losses in a PEMEC. In addition, in some embodiments, effective operation can be provided even with a low catalyst loading (e.g., from about 0.02 mg/cm² to about 0.35 mg/cm²), thus reducing the requirement of several mg/cm² of conventional configurations and decreasing the catalyst material cost accordingly. However, as also discussed herein above, the loading can be lowered down to as low as 0.005 mg/cm² or increased up to 3.0 mg/cm², depending on various application scenarios.

By way of elaboration and not limitation, in some embodiments, the presently disclosed subject matter provides a loading range of about 0.005 to about 3.0 mg/cm², including about 0.02 to about 3.0 mg/cm². In accordance with the presently disclosed subject matter, the catalyst layer technologies disclosed herein can achieve a good control of catalyst loadings from 0.005 to 3.0 mg/cm². Second, in accordance with the presently disclosed subject matter, it is demonstrated that the catalysts with the low catalyst loading range of 0.02 to 0.35 mg/cm² (including about 0.02, 0.05, 0.1, 0.15, 0.20, 0.25, 0,30, or 0.35 mg/cm²) can achieve good cell performance. However, the loading can be lowered down to as low as 0.005 mg/cm² or increase up to 3.0 mg/cm² or above, depending on a given application scenario. In some embodiments, after a certain point loading more catalyst has diminishing gains in performance. Thus, in some embodiments, the catalyst comprises an active metal loading on the anode side of a substrate of no greater than about 1 mg/cm² (including about 0.01, 0.02, 0.05, 0.1, 0.15, 0.20, 0.25, 0,30, 0.35, 0.50, 0.75, or 1 mg/cm²) and on the cathode side of a substrate no greater than about 0.15 mg/cm² (including about 0.01, 0.02, 0.05, 0.1, or 0.15 mg/cm²).

There is no limit to the dimensions of electrodes with the synthesis method disclosed herein, which makes it more applicable in industrial applications. As a result, the porous IrOₓ-NS CCLGDL can provide a combination of high catalytic activity, excellent electrode electronic conductivity, great structural stability, and excellent liquid/gas transport properties. For instance, when a cell performance test was conducted at a temperature of 80° C. and water flow rate of 20 mL/min at the anode side with a NAFION™117 membrane (used as a representative, non-limiting example), an example configuration of a porous IrOₓ-NS CCLGDL achieved a low catalyst loading of 0.28 mg/cm² while delivering a current density up to 4000 mA/cm² at a cell voltage of 2.02 V, which is superior to previously reported noble metal-based OER electrodes in PEMECs up to date. The stability test of porous IrOₓ-NS CCLGDL under a high current density of 1800 mA/cm² exhibits an excellent electrode stability, as demonstrated by a small performance loss over 120 h. Within the low catalyst loading range of about 0.02 mg/cm² to about 0.35 mg/cm², the electrode can have a stability within a small degradation range of about 0.01 mV/h to about 0.3 mV/h. In some embodiments, the cell voltage can be in a range from about 1.9 V to about 2.02 V at a high current density of 4000 mA/cm².

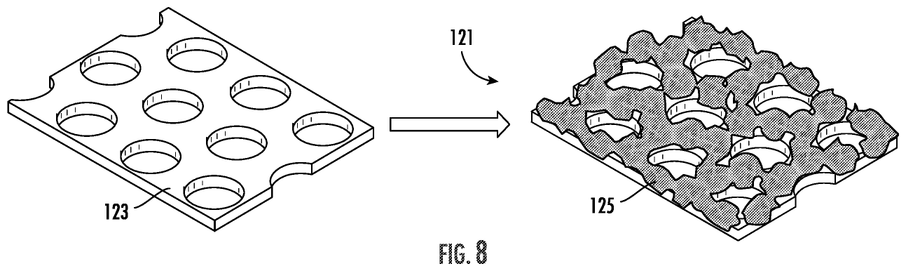

The schematic in FIG. 8 illustrates the fabrication of the porous IrOₓ-NS CCLGDL via a facile and simple chemical route to in-situ grow IrOₓ-NS catalyst layers on the TTLGDL substrate. In one example embodiment, the substrate can be a thin titanium LGDL with about 200 μm pore size and about 40% porosity. The LGDL substrate can be immersed into a reaction solution containing iridium precursors and a mild reducing agent (e.g., formic acid (HCOOH)), and then the substrate can be heated to an elevated temperature in a water bath (e.g., at a temperature in a range from about 60° C. to about 90° C. at ambient pressure and for a reaction time in a range from about 5 hours to about 24 hours) to obtain the porous IrOₓ-NS CCLGDL, in which IrOₓ-NS catalyst layer is substantially uniformly grown on the TTLGDL substrate. It is worth noting that the entire synthesis process is facile and simple, cost-effective and environment friendly, without requirements of pH control and elaborate equipment, which makes it easily scalable for future industrial applications in various genres of electrochemical devices.

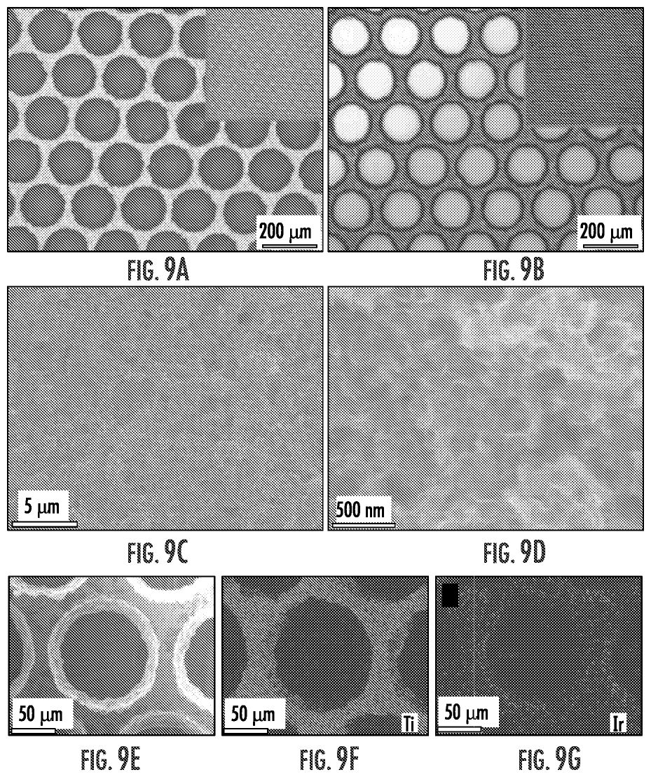

As shown in FIG. 9A, the applied thin titanium LGDL substrates in this example configuration show well-defined circular pore morphology with the average pore size of about 200 μm, calculated porosity of about 40% and about 50 μm in thickness. The surface of LGDL substrates is relatively smooth. The inset photo in FIG. 9A shows the light gray LGDL substrate prior to IrOₓ-NS growth. After IrOₓ-NS growth, the surface of LGDL substrates becomes much rougher than pristine LGDL, and the color turns from light to dark, as shown in FIG. 9B. The high-resolution SEM images in FIGS. 9C and 9D reveal that porous IrOₓ-NS with abundant exposure edges were successfully grown on carbon nanolayer coated LGDL substrates with a full surface coverage and good uniformity. The SEM-EDX mapping images in FIG. 9E-9G show the homogenous elemental distribution of titanium and iridium in the porous IrOₓ-NS CCLGDL, further confirming the uniform surface coverage of IrOₓ-NS on LGDL substrates.

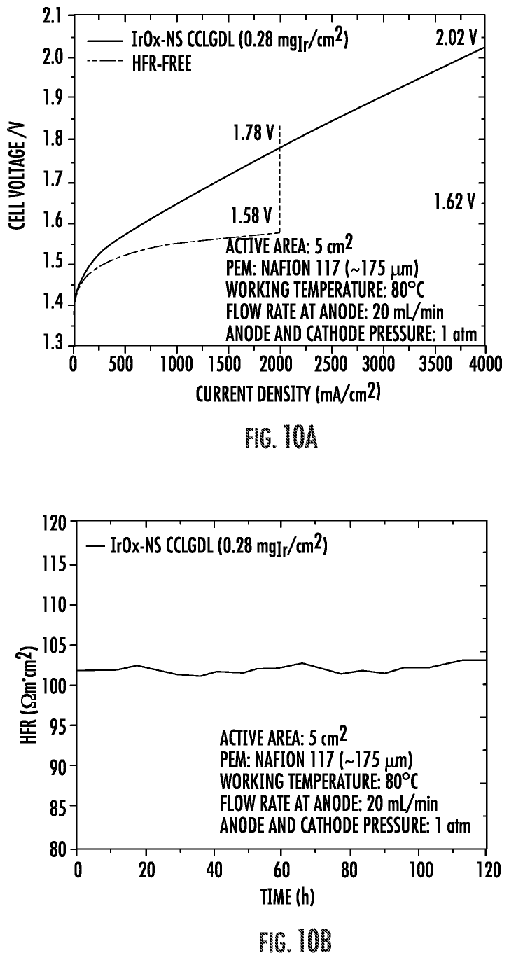

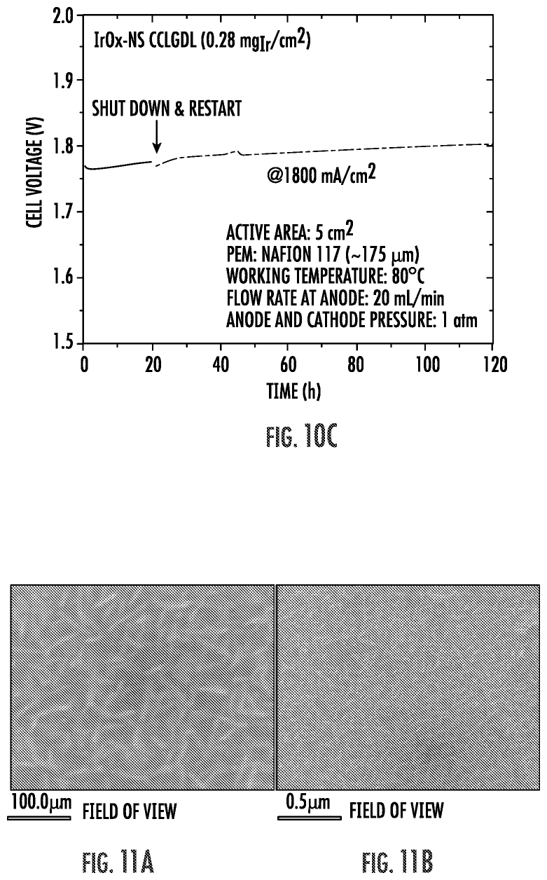

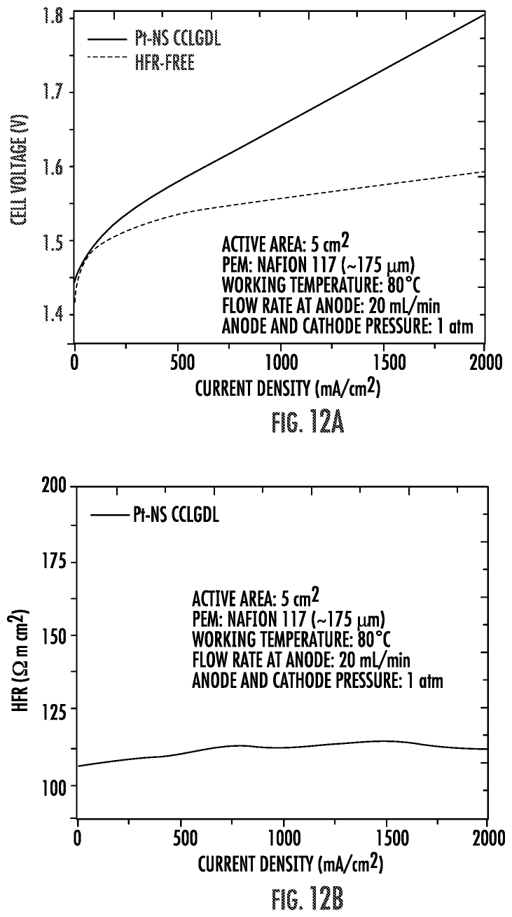

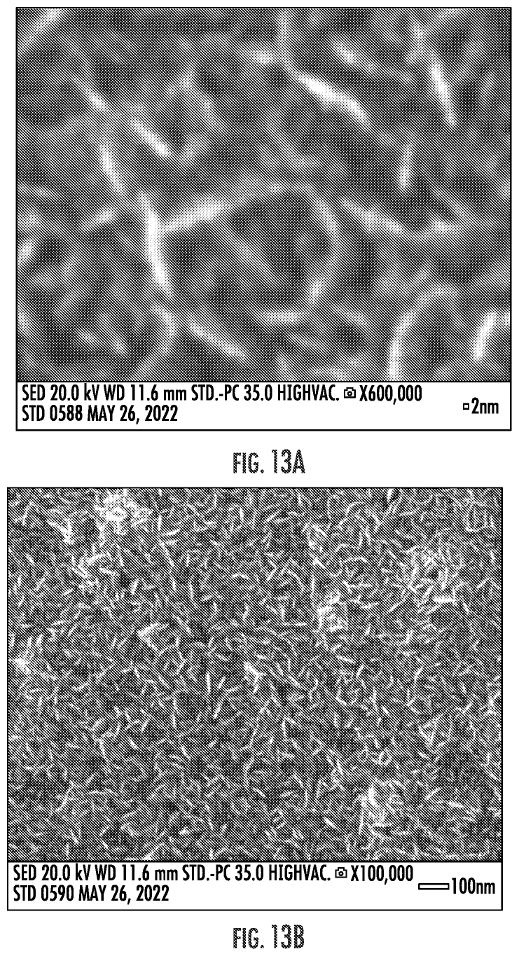

When coupled with a membrane (e.g., a sulfonated tetrafluoroethylene based fluoropolymer-copolymer membrane, such as a NAFION™117 membrane as a representative, non-limiting example), the polarization curves in FIG. 10A show that the porous IrOₓ-NS CCLGDL with a low catalyst loading of 0.28 mgIr/cm² can deliver the current densities of 1000, 2000, and 4000 mA/cm² at low cell voltages of 1.65, 1.78 and 2.02 V, respectively. FIG. 10B shows the high-frequency resistance (HFR) plot of the cell with the porous IrOₓ-NS CCLGDL with an average HFR of about 102 mΩ cm². As seen from FIG. 10C, the stability test of porous IrOₓ-NS CCLGDL under an extremely high current density of 1800 mA/cm² exhibits an excellent electrode stability, as demonstrated by a small performance loss (e.g., about 0.2 mV/h) over 120 h. The above results demonstrate that ionomer-free IrOₓ-NS CCLGDL design in this work can effectively reduce the catalyst loading and meanwhile achieve significantly improved catalyst utilization and excellent stability during the long-term operation under extremely high current densities. As a result, the total system cost associated with catalyst consumption and electrode fabrication can be greatly reduced for hydrogen production in large-scale PEM or other solid polymer electrolyte water electrolyzers. In other embodiments, the electrode assemblies disclosed herein can be directly used in liquid electrolyte systems. The liquid electrolytes (e.g., H₂SO₄, KOH, NaOH, etc.) with a representative concentration range of about 0.1 M˜1 M can be employed for various electrochemical device applications such as acidic or alkaline water electrolyzers, fuel cells, CO₂/N₂ electrolyzers and so forth.

### Platinum-Nanosheet-Coated Electrodes

In another embodiment, a facile and fast electroplating process can be used to prepare a template-free and surfactant-free platinum nanosheet (Pt-NS) catalyst-coated thin LGDL (CCLGDL) at room temperature. As with the other configurations discussed herein, such a CCLGDL can serve as an ionomer-free electrode for high-efficiency electrochemical cells, showing remarkably promoted activity and electrode robustness. As illustrated in FIGS. 11A and 11B, ultrathin platinum nanosheets (e.g., having a thickness of about 6.5 nm) with a small average nanosheet size (e.g., having an average nanosheet size of about 30 nm) can be electroplated onto the LGDL substrate, exhibiting good coverage and uniformity. In the illustrated embodiment, platinum loading is approximately 0.025 mg/cm² (e.g., from about 0.015 mg/cm² to about 0.050 mg/cm², including about 0.015 mg/cm², 0.020 mg/cm², 0.025 mg/cm², 0.030 mg/cm², 0.035 mg/cm², 0.040 mg/cm², 0.045 mg/cm², or 0.050 mg/cm²) with the full surface coverage of uniform platinum nanosheets on the LGDL substrate having pore sizes of about 200 μm (e.g., from about 50 μm to about 400 μm, including about 50, 100, 150, 200, 250, 300, 350, or 400 μm) and a porosity of about 40% (e.g., ranging from about 20% to about 70%, including about 20, 25, 30, 35, 40, 45, 50, 55, 60, 65, or 70%). In addition, the loading and size of the platinum nanosheets can be well-tuned by changing the electrodeposition time. Further, in some embodiments, a high constant potential in a range of about −0.5 V vs. SCE to about −2 V vs. SCE (e.g., −1 vs. SCE) is used for the platinum nanosheet ultrafast electroplating. In some embodiments, this fabrication can be performed at ambient pressure and at room temperature, although desirable coatings can be produced at any of a range of temperatures from about 20° C. to about 90° C. A similar electroplating process can be used to electroplate other PGM materials such as iridium, ruthenium, palladium, or gold, etc. and non-PGM materials including but not limited to nickel-based materials, iron-based materials, cobalt-based materials, molybdenum-based materials, or combinations thereof.

Such platinum nanosheet (Pt-NS) catalyst-coated LGDL can exhibit a range of advantages. First, by using a facile and fast electroplating process at room temperature, a platinum catalyst layer with fine nanosheets can be easily deposited on the surface of the LGDL to form a Pt-NS CCLGDL, which is time-saving and energy-saving and thus can promote the large-scale production of the CCLGDL and the industrial application of electrolyzer cells, fuel cells, and other energy conversion devices. In addition, in some embodiments, the fine platinum nanosheets can be easily obtained without any surfactant and template, thereby making the production more facile and simpler. Meanwhile, in some embodiments, different electroplating methods such as constant voltage electroplating, constant current density electroplating, pulse electroplating can be used to grow Pt-NS. Further, in some embodiments, the size and loading of the Pt-NS can be well-tuned. Because of this improved control over the process, low loading of platinum nanosheets (e.g., from about 0.015 mg/cm² to about 0.050 mg/cm² or less) with good uniformity and coverage can be easily formed on the substrates. At the same time, in some embodiments, the obtained platinum nanosheets show large surface areas and thus can expose abundant reaction sites. In any application, the electroplated Pt-NS CCLGDL can be ionomer-free, which can not only reduce the ohmic resistance but also avoid the stability issue from the ionomer degradation.

By way of elaboration and not limitation, in some embodiments, the presently disclosed subject matter provides a loading range of about 0.002 to about 3.0 mg/cm². In accordance with the presently disclosed subject matter, the catalyst layer technologies disclosed herein can achieve a good control of catalyst loadings from 0.005 to 3.0 mg/cm². Second, in accordance with the presently disclosed subject matter, it is demonstrated that the catalysts with the low catalyst loading range of 0.02 to 0.35 mg/cm² (including about 0.02, 0.05, 0.1, 0.15, 0.20, 0.25, 0,30, or 0.35 mg/cm²) can achieve good cell performance. However, the loading can be lowered down to as low as 0.002 mg/cm² or increase up to 3.0 mg/cm² or above, depending on a given application scenario. In some embodiments, after a certain point loading more catalyst has diminishing gains in performance.

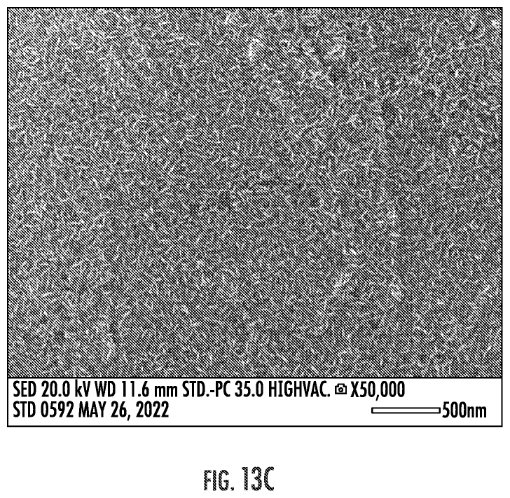

As a result, in some embodiments, the developed Pt-NS CCLGDL can be used as a highly efficient cathode electrode in a PEMEC, showing remarkable cell performance with a low platinum loading. In one example configuration shown in FIG. 12A, when combined with an anode-only catalyst coated membrane (e.g., a NAFION™117 membrane), the Pt-NS CCLGDL exhibits a low cell voltage of 1.807 V with a low platinum loading of 35 μg/cm² to achieve 2000 mA/cm². Based on the HFR plot (average value: ˜107 mΩ cm²) in FIG. 12B, a low HFR-free cell voltage of 1.585 V is also demonstrated at 2000 mA/cm². The Pt-NS can be electroplated on various LGDLs with low platinum loadings (e.g., ranging from about 0.020 mg/cm² to about 0.050 mg/cm²) to achieve low overpotential (e.g., ranging from about 1.80 V to about 1.86 V). These performances are superior to reported cell performances so far. The outstanding performance with the low platinum loading can be ascribed to the fine nanosheet structures, which show a large surface area exposing rich active reaction sites. In other embodiments, the electrode assemblies disclosed herein can be directly used in liquid electrolyte systems. The liquid electrolytes (e.g., H₂SO₄, KOH, NaOH, etc.) with a representative concentration range of about 0.1 M˜1 M can be employed for various electrochemical device applications such as acidic or alkaline water electrolyzers, fuel cells, CO₂/N₂ electrolyzers and so forth.

### Iridium-Nanosheet-Coated Electrodes

In another embodiment, iridium nanosheets (Ir-NS) are uniformly electroplated on the liquid/gas diffusion layer. In some embodiments, a facile and fast electroplating process is used to fabricate template-free and surfactant-free iridium nanosheets on substrates composed of titanium or other metallic or graphite or composite substrates. In some embodiments, the liquid/gas diffusion layer can include thin-tunable liquid/gas diffusion layers (TTLGDLs), titanium foam, titanium felt, and titanium mesh. Apart from the titanium substrates, other metallic substrates (e.g., nickel), carbon-based substrates (e.g., carbon papers, carbon cloth), and composite substrates can also be used to electroplate the fine iridium nanosheets.

The iridium nanosheets can be electroplated on titanium substrates using an electroplating solution comprising iridium compounds (e.g., having concentrations of about 10 g-Ir/L to about 20 g-Ir/L), an example of which is produced by Electroplating Engineers of Japan Ltd. under the name IRIDEX 300 B. In some embodiments, this fabrication can be performed at ambient pressure and at any of a range of temperatures from about 80° C. to about 90° C. In some embodiments, the Ir-NS electroplating is achieved using a two-electrode system, although those having ordinary skill in the art will appreciate that a three-electrode electroplating system is also feasible.

In some embodiments, the catalyst coating can be applied with tunable loadings ranging from between about 0.03 mg/cm² to 1 mg/cm² (including about 0.03, 0.05, 0.1, 0.15, 0.2, 0.25, 0.3, 0.35, 0.50, 0.75, or 1 mg/cm²), although as also discussed herein above, the loading can be as low as 0.005 mg/cm² or as high as 3.0 mg/cm², depending on various application scenarios. In some embodiments, the Ir-NS formation can be affected by the substrate type and current density applied since different substrate types show different electroplating current density ranges. Specifically, for example, the Ir-NS electroplating current density can be in a range from about 5 mA/cm² to about 17 mA/cm² when applied to titanium foam with 3-dimensional structures, whereas the current density range can be in a range from about 1 mA/cm² to about 4 mA/cm² when applied to a TTLGDL or titanium foil with 2-dimensional structures.

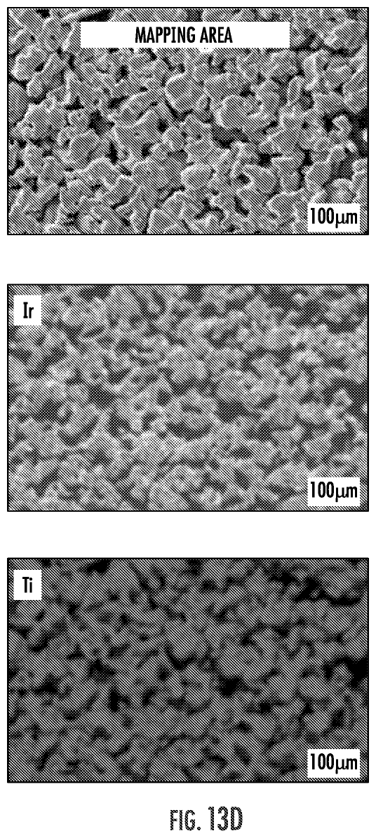

As shown in FIGS. 13A-13C, abundant iridium nanosheets were successfully electroplated on the titanium substrate surface, showing fine nanosheet morphologies. As presented in SEM-EDX mapping results shown in FIG. 13D, iridium can be uniformly distributed on the titanium substrates, demonstrating the good uniformity and surface coverage of the iridium nanosheets.

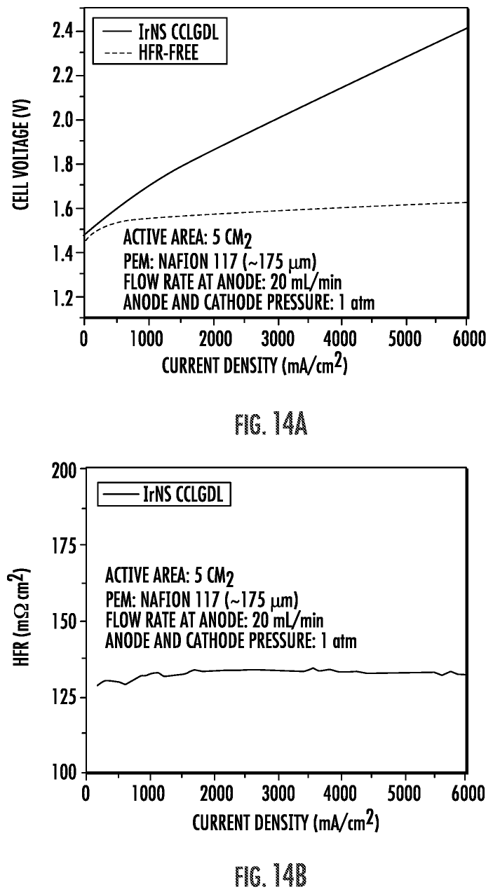

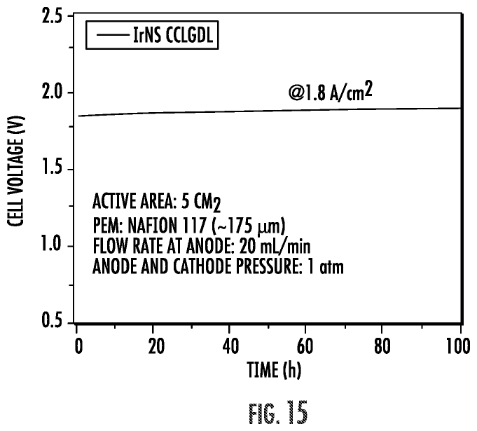

In some embodiments, the prepared Ir-NS CCLGDL is used as an ionomer-free anode electrode for high-efficiency electrolyzer cells, achieving remarkable cell performance showing remarkable activity and stability for the electrolyzer. As presented in FIG. 14A, when combining with a NAFION™ 117 membrane and cathode electrode, the Ir-NS CCLGD exhibits low cell voltages of 1.851, 2.140, and 2.412 V to achieve current densities of 2, 4, and 6 A/cm², respectively. Moreover, low HFR-free cell voltages of 1.582, 1.604, 1.621 V are also demonstrated at respective current densities of 2, 4, and 6 A/cm². In addition, as shown in FIG. 14B, an average HFR value of 132 mΩ·cm² is demonstrated from 0 to 6 A/cm². These performances are superior to most of the reported cell performances in the prior art. The performance can in part be ascribed to the fine nanosheet morphologies, which offer a large surface area and expose rich active reaction sites. Moreover, as shown in FIG. 15, the stability of the Ir-NS CCLGDL is evaluated at a high current density of 1.8 A/cm² for 100 hours, showing a small degradation rate of about 0.32 mV/h.

In some embodiments, compared with other reported electrodes for the electrolyzer cells, the Ir-NS CCLGDL exhibits a wide range of advantages. Namely, with a facile and fast electroplating process, fine iridium nanosheets with good surface coverage and uniformity can be easily deposited on the substrates to form Ir-NS CCLGDL, which is highly efficient and energy-saving and thus can be easily scaled up for the industrial PEM electrolyzer cells. In addition, the fine iridium nanosheets can be easily obtained in a template-free and surfactant-free condition, which is facile and chemical saving. Low iridium loadings with fine nanosheet morphologies and good surface coverage can be easily formed on the substrates, and abundant reaction sites and high activity can be achieved due to the large surface area of the fine iridium nanosheets. Further, the electroplated Ir-NS CCLGDL is ionomer-free, which can improve the catalyst utilization, reduce the ohmic resistance, and avoid NAFION™ collapse in the catalyst layer.

In addition to titanium substrates of TTLGDL, titanium foam, titanium felt, titanium mesh, the integrated Ir-NS electrode can further be easily extended to any of a variety of other substrates, including but not limited to carbon papers, carbon cloth, other metallic substrates (e.g., nickel, copper), or composite substrates to form Ir-NS electrodes. In addition, apart from applying to the PEMEC, the developed Ir-NS has applications in other solid or liquid electrolyte electrolyzers, fuel cells, unitized regenerative fuel cells, sensors, or other electrochemical cells.

### Modified IrOₓ Integrated Electrodes

In another embodiment, a modified IrOₓ catalyst layer is combined with TTLGDLs via an electroplating process that can be conducted at a temperature within a range of about 20° C. to about 90° C. (e.g., including at room temperature) and at ambient pressure, where x is a value in the range of 0≤x≤2.0. In particular, in some embodiments, the catalyst is coated on the TTLGDL using cyclic voltammetry (CV) electroplating (e.g., from about −0.85 to about 1.0 Vs. SCE with a scan rate of 50 mV/s). In some embodiments, the chemical state of the modified IrOₓ can be tuned by changing the scan rate of the cyclic voltammetry (CV) electroplating (e.g., having a scan rate of about 10, 20, 30, 40, 50, 60, 70, 80, 90, 100, 110, 120, 130, 140, or 150 mV/s). In some embodiments, the electrolyte for the process can include iridium precursor and oxalic acid into deionized water, with further components being added to tune the pH (e.g., with NaOH, K₂CO₃, or KOH, etc.). In some particular embodiments, the iridium precursor concentration is in a range from about 0.5 mmol L⁻¹ to about 10 mmol L⁻¹ and the aging time for the formation of intermediate iridium complex is in a range from about 10 hours to about 3 days. Further, a surfactant can be added into the electrolyte to prepare a modified IrOₓ catalyst layer with porous structures to offer a larger surface area with more reaction active sites exposed. In such a process, the size of the porous structures can be well tuned by adjusting different amounts and types of surfactants. In some embodiments, the larger amount of the surfactant is added, a more porous structure is expected to obtain. In addition, in some embodiments, the pore size can be expected to increase by adding surfactants with larger molecular weights. Any of a variety of surfactants can serve this purpose, including but not limited to PEO₄₅₀₀-PPO₃₂₀₀-PEO₄₅₀₀, PEO₆₃₀₀-PPO₃₂₀₀-PEO₆₃₀₀, a hydrophilic non-ionic surfactant comprising a triblock copolymer comprising a central hydrophobic block of polypropylene glycol flanked by two hydrophilic blocks of polyethylene glycol (PEG) commercially available under the tradename Pluronic F127, or a polyethylene glycol hexadecyl ether surfactant available under the tradename Brij 58.

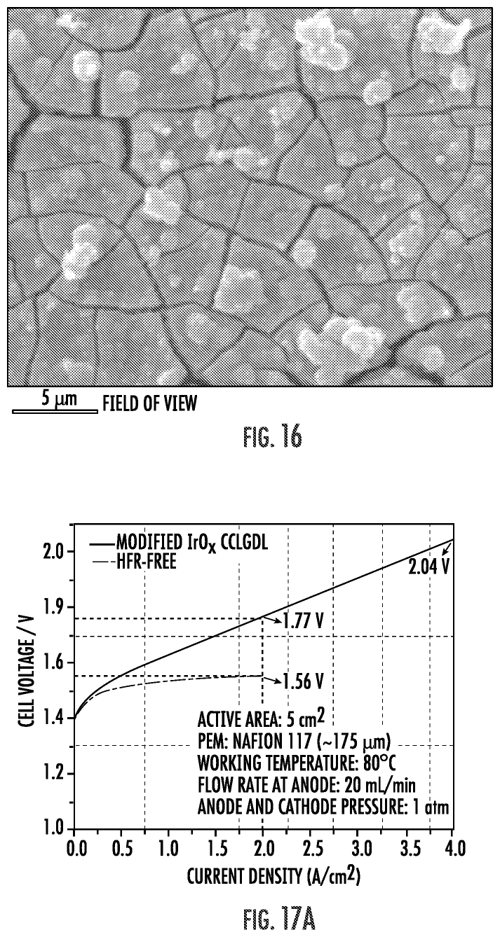

In this way, as shown in FIG. 16, a modified IrOₓ catalyst layer is substantially uniformly coated on the surface of TTLGDL with nanoparticle features along with some cracks. As used herein, the term “modified” refers to the IrOₓ catalyst layer being modified with more oxidized states of iridium compared to the IrOₓ nanosheet catalysts discussed above. In some embodiments, such crack formation is a result of high internal stress in the catalyst layer, which can develop from a combination of electrolyte composition, electroplating method, catalyst composition, and/or catalyst loading. In some embodiments in which it is desirable to mitigate and/or prevent crack formation, additives (e.g., saccharin with an amount from about 0.5 g/L to about 5 g/L, or other additives such as benzene sulfonic acid, coumarin, and picoline) can be added in the electrolyte to decrease the internal stress and then effectively minimize the crack in the catalyst layer. Alternatively or in addition, in some embodiments, applying ultrasound during the electroplating process can decrease the internal stress to minimize the crack formation. In some configurations, however, the fine cracks may provide some benefits. Notably, the cracks in the catalyst layer not only offer a large surface area but also boost the mass transport during the cell operation, which can promote gas and water diffusion across the reaction sites in the electrolyzer cells.

Similar to the embodiments discussed above, this modified IrOₓ catalyst-coated LGDL (modified IrOₓ CCLGDL) can provide a range of advantages. First, in some embodiments, abundant electronic defects and unsaturated coordination sites of the modified IrOₓ catalyst layer can offer rich reaction sites and thus decrease activation losses in the PEMEC. In addition, through a simple and facile electroplating process at room temperature, the modified IrOₓ CCLGDL can be easily obtained, which can be easily extended to large iridium CCLGDL fabrication without dimension limitation for industrial applications. Further, the electroplated modified IrOₓ CCLGDL is ionomer-free and thus can further reduce the ohmic resistance and avoid the stability issue from the NAFION™ layer degradation. In some embodiments, the low loading (e.g., in a range of about 0.02 mg/cm² to about 0.35 mg/cm² or less) of the modified IrOₓ catalysts on the multifunctional TTLGDLs can result in remarkably reduced cost while still providing excellent cell performances.

By way of elaboration and not limitation, in some embodiments, the presently disclosed subject matter provides a loading range of about 0.005 to about 3.0 mg/cm², including about 0.02 to about 3.0 mg/cm². In accordance with the presently disclosed subject matter, the catalyst layer technologies disclosed herein can achieve a good control of catalyst loadings from 0.005 to 3.0 mg/cm². Second, in accordance with the presently disclosed subject matter, it is demonstrated that the catalysts with the low catalyst loading range of 0.02 to 0.35 mg/cm² (including about 0.02, 0.05, 0.1, 0.15, 0.20, 0.25, 0,30, or 0.35 mg/cm²) can achieve good cell performance. However, the loading can be lowered down to as low as 0.005 mg/cm² or increase up to 3.0 mg/cm² or above, depending on a given application scenario. In some embodiments, after a certain point loading more catalyst has diminishing gains in performance. Thus, in some embodiments, the catalyst comprises an active metal loading on the anode side of a substrate of no greater than about 1 mg/cm² (including about 0.01, 0.02, 0.05, 0.1, 0.15, 0.20, 0.25, 0,30, 0.35, 0.50, 0.75, or 1 mg/cm²) and on the cathode side of a substrate no greater than about 0.15 mg/cm² (including about 0.01, 0.02, 0.05, 0.1, or 0.15 mg/cm²).

As shown in FIG. 17A, low cell voltages of only 1.77 V and 2.04 V are demonstrated at current densities of 2 A/cm² and 4 A/cm², respectively, when combining the modified IrOₓ CCLGDL with a cathode-only catalyst coated membrane (e.g., a NAFION™117 membrane). With the HFR plot recorded within about 0-2 A/cm² in FIG. 17B (e.g., having an average value of about 107 mΩ cm²), a low HFR-free cell voltage of 1.56 V is demonstrated at the current density of 2 A/cm². Moreover, as shown in FIG. 18, the stability of the modified IrOₓ CCLGDL is evaluated at a high current density of 1.8 A/cm² for 80 hours. After the first 2 h for cell performance stabilizing, it exhibits a small degradation rate of only 0.124 mV/h with a catalyst loading of about 0.3 mg/cm². Based on experimental results, the catalyst loading can affect the performance degradation rate when the catalyst loading is in the range of 0.02 mg/cm² to about 0.35 mg/cm², with a degradation rate having a range of about 0.1 mV/h to about 0.3 mV/h. Generally, a higher catalyst loading can provide a better performance stability with a smaller degradation rate, but the catalyst cost is relatively higher than a lower catalyst loading. In other embodiments, the electrode assemblies disclosed herein can be directly used in liquid electrolyte systems. The liquid electrolytes (e.g., H₂SO₄, KOH, NaOH, etc.) with a representative concentration range of about 0.1 M˜1 M can be employed for various electrochemical device applications such as acidic or alkaline water electrolyzers, fuel cells, CO₂/N₂ electrolyzers and so forth.

### Chemically Synthesized Bimetallic Nanostructured Iridium-Based Catalyst-Coated Electrodes

In some embodiments, the catalyst coating is a chemically synthesized bimetallic nanostructured IrMOₓ catalyst that is grown in-situ on the substrate, where M is a component selected from the group including ruthenium, rhodium, gold, platinum, osmium, palladium, cobalt, manganese, molybdenum, nickel, iron, tungsten, and the like, and where x is any of a range of values in the range of 0≤x≤2.0 corresponding to known oxides and/or non-stoichiometric compounds, although other non-precious transition metals (e.g., Co, Mn, Mo, Ni, Fe, W, etc.) can also be used in some circumstances. As one example, a bimetallic nanostructured IrRuOₓ catalyst is in-situ deposited onto the surface of a titanium substrate. In some embodiments, such a composition can be achieved by introducing a ruthenium precursor into the reaction solution used for the process discussed above with respect to forming the porous IrOₓ-NS-based catalyst layer. Similarly, other configurations for a bimetallic coating of IrMOₓ catalysts can be formed by adding the desired new precursor (e.g., ruthenium, rhodium, gold, platinum, osmium, palladium, cobalt, manganese, molybdenum, nickel, iron, tungsten, etc.) into the reaction solution of IrOₓ-NS. In some embodiments, such a reaction can be performed at a temperature within a range of about 60° C. to about 90° C. and at ambient pressure.

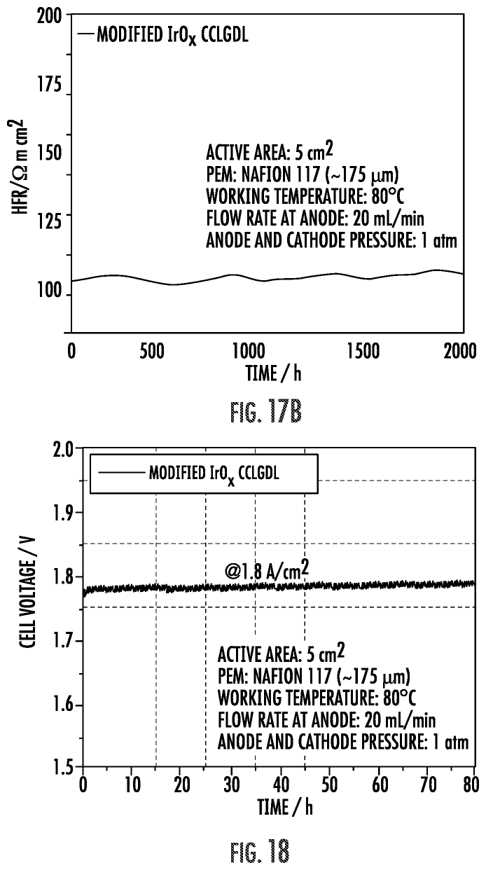

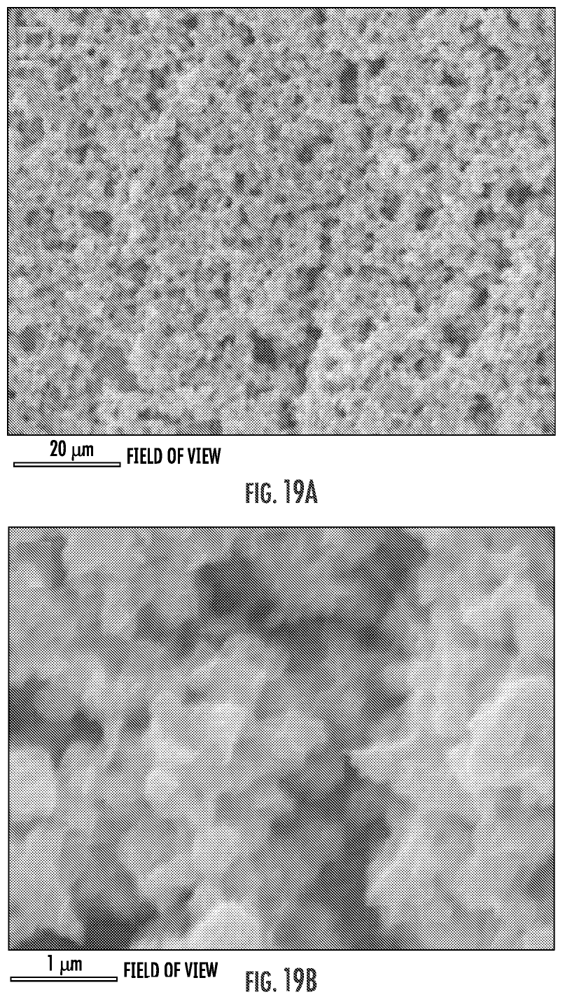

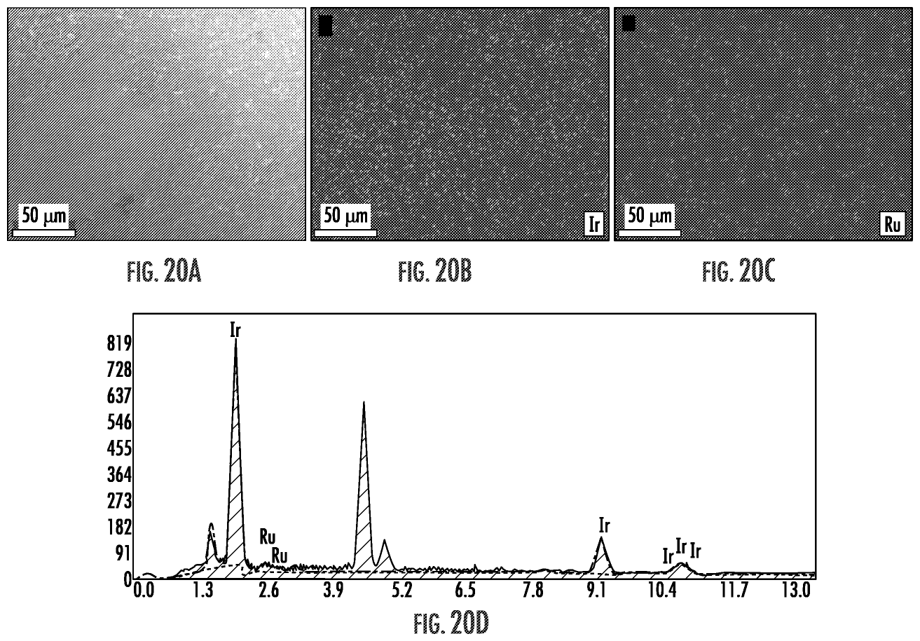

As shown in FIGS. 19A and 19B, the chemically synthesized bimetallic nanostructured IrRuOₓ catalysts (nanostructured-IrRuOₓ) can be substantially uniformly grown on the substrate with substantially full surface coverage. From the high magnification SEM image, the nanoporous structures are observed, which can offer the catalysts with a large surface area and thus expose rich active reaction sites for the electrochemical reactions. As seen from the SEM and EDX mapping characterization results (FIGS. 20A-20D), elements of iridium and ruthenium are observed to be uniformly distributed in the catalyst layer, further demonstrating the successful growth of the bimetallic IrRuOₓ catalysts with good uniformity and surface coverage on the titanium substrate.

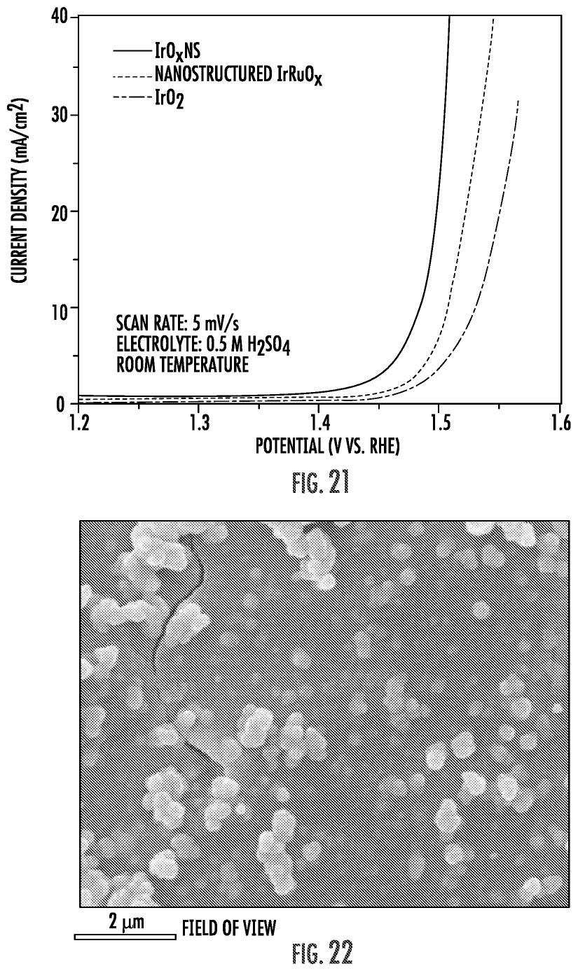

In some embodiments, the electrode assemblies disclosed herein can be directly used in liquid electrolyte systems. In any application, such a nanostructured IrRuOₓ catalyst provides improved OER performance. As shown in FIG. 21, to drive a current density of 10 mA/cm² in 0.5 M H₂SO₄, nanostructured-IrRuOₓ/Ti with a low loading of 0.25 mg/cm² demonstrates a low overpotential of 252 mV, which is significantly lower than that of the commercial IrO₂ (299 mV). The excellent performance can at least partially be attributed to the introduced ruthenium that improves the catalyst intrinsic activity and then reduces the reaction overpotentials. In some embodiments, the atomic ratio of iridium to ruthenium in this embodiment is about 8:2, although good performance can be achieved with ratios in a range from about 9:1 to about 1:9. Moreover, the as-prepared electrode with rich defects and a large surface area can expose abundant active reaction sites, which further decreases the overpotentials and thus results in superior performance.

In addition to some of the benefits discussed above of the electrode designs presented here, the bimetallic nanostructured IrMOₓ catalyst-coated electrode design can provide additional advantages compared with previous electrodes configurations. In some embodiments, for example, compared to a conventional IrOₓ catalyst-coated electrode, the introduction of ruthenium enhances the catalyst intrinsic activity, contributing to outstanding electrochemical performance. In addition, in some embodiments, the cost of ruthenium can often be much lower than that of iridium, and by tuning the atomic ratio of iridium and ruthenium, the chemically synthesized nanostructured IrMOₓ catalysts can show both excellent activity and stability, which can significantly promote the large-scale application of the PEM or other solid polymer electrolyte electrolyzers. As discussed above, for example, in some embodiments, the atomic ratio range of Ir:Ru in the co-electroplated catalysts can be from 9:1 to 1:9 (e.g., Ir:Ru=9:1, 8:2, 7:3, 6:4, 5:5, 4:6, 3:7, 2:8, 1:9 or at any of a variety of ratios therebetween). Furthermore, the benefits of this structure are not limited to the use of ruthenium into the IrOₓ-NS catalysts, and various noble metals such as rhodium, gold, platinum, osmium, and palladium and non-noble metals such as cobalt, manganese, molybdenum, nickel, iron, and tungsten can be used to replace the ruthenium to form other bimetallic nanostructured IrMOₓ catalysts coated electrodes. In any combination, the nanostructured IrMOₓ catalysts can provide abundant defects, and a large surface area can offer rich active reaction sites for electrochemical reactions, which can result in enhanced intrinsic activity and remarkably reduced overpotential or activation loss. In some embodiments, the in-situ growth of bimetallic nanostructured IrMOₓ catalysts on the substrate in an ionomer-free process can not only avoid the NAFION™ binder degradation and resultant stability issues but also reduce the ohmic resistance and mass transport resistance.

The electrode configurations and methods discussed above can improve the catalytic activity and stability of iridium-based OER catalysts in a number of aspects. With respect to the catalyst composition, the OER catalysts that are used for the real proton exchange membrane electrolyzer cells (PEMECs) have predominately been Ir, IrOₓ, or IrO₂ materials, which show limited activity and thus need high catalyst loadings to ensure good performance and long stability. Hence, by coupling other metals such as ruthenium, rhodium, gold, platinum, osmium, cobalt, manganese, molybdenum, nickel, iron, and tungsten with iridium to be stable anode catalysts for PEMECs, an enhancement to the intrinsic activity of the catalysts and a reduction in the catalyst loading can be achieved. With respect to the morphology of such configurations, it can be efficient to engineer the catalysts with nanostructured features with abundant reaction active sites, such as designing one-dimensional needles and nanowires, two-dimensional ultrathin sheets, and three-dimensional structures featuring abundant mesopores. In addition, in some embodiments, other morphologies of nanoparticles, nanorods, and nanotubes can be fabricated with some modifications of the chemical synthesis method of bimetallic nanostructured IrMOₓ catalysts disclosed herein. For synthesis of nanoparticles, modified synthesis methods can include a change in the surfactant type to obtain nanoparticle structures. Any of a variety of surfactants can be used for this purpose, including but not limited to poly vinyl pyrrolidone (PVP), poly vinyl alcohol (PVA), poly oxyethylene lauryl ether (POLE), a hydrophilic non-ionic surfactant comprising a triblock copolymer comprising a central hydrophobic block of polypropylene glycol flanked by two hydrophilic blocks of polyethylene glycol (PEG) commercially available under the tradename Pluronic F127 or a polyethylene glycol hexadecyl ether surfactant available under the tradename Brij 58. For synthesis of nanorods, the one-dimensional template (e.g., Te, Ag nanowires) can be used as the inner core to grow the catalysts on the template surface to form nanorod structures. For synthesis of nanotubes, the one-dimensional template (e.g., Te, Ag nanowires) can be used as the inner core to grow the catalysts on the template surface, and the inner template can be removed to form nanotube structures. Moreover, the formation of particular structures of IrMOₓ (M=ruthenium (Ru), rhodium (Rh), palladium (Pd), osmium (Os), iridium (Ir), platinum (Pt), gold (Au), silver (Ag), cobalt (Co), manganese (Mn), molybdenum (Mo), nickel (Ni), iron (Fe), tungsten (W), etc.) can generate the defects in the catalysts for OERs.

### Co-Electroplated Bimetallic Electrodes

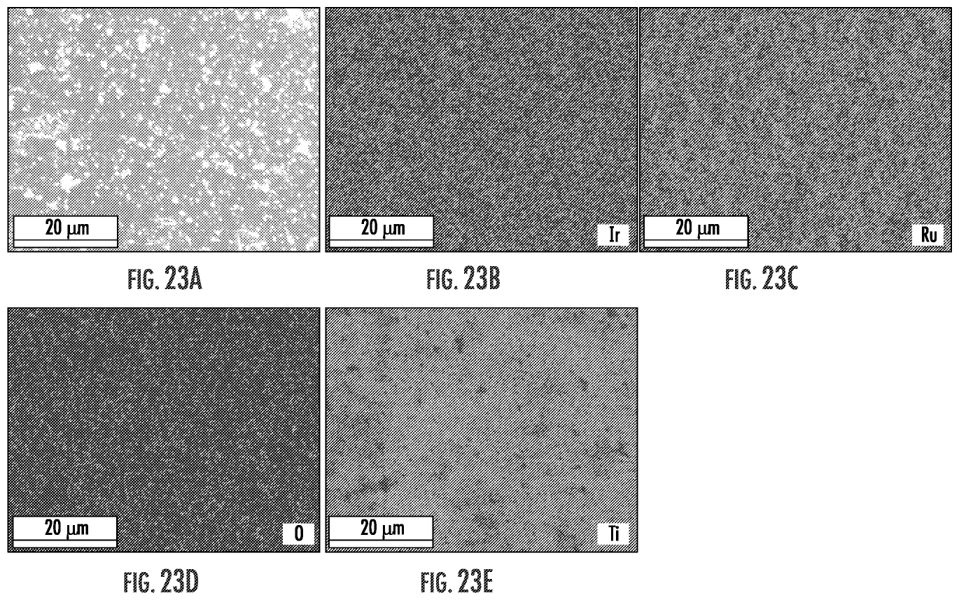

In another embodiment, an efficient electrode integration design provides co-electroplated bimetallic catalysts with tunable atomic ratios on the TTLGDL to form a CCLGDL via a simple electroplating method. In some embodiments, the bimetallic catalyst includes two metal components selected from the group including iridium, ruthenium, rhodium, gold, platinum, osmium, palladium, and the like, although other non-precious transition metals (e.g., Co, Mn, Mo, Ni, Fe, W, etc.) can also be used in some circumstances. In particular, in some embodiments, the catalyst is an IrRuOₓ-based catalyst coated on the TTLGDL using a pulse co-electroplating method with an applied current density in a range from about 2 mA/cm² to about 500 mA/cm², where x is a value in the range of 0≤x≤2.0. Notably, the atomic ratio of the co-electroplated iridium and ruthenium can be well modulated by controlling the iridium and ruthenium precursor concentrations in the electrolyte. In some embodiments, the atomic ratio range of Ir:Ru in the co-electroplated catalysts is from 9:1 to 1:9 (e.g., Ir:Ru=9:1, 8:2, 7:3, 6:4, 5:5), which can be obtained by tuning the nominal precursor concentration from 9:1 to 1:9. Moreover, the chemical state and composition of the co-electroplated iridium and ruthenium can be effectively engineered by modifying the electroplating methods, such as employing pulse electroplating, pulse reverse electroplating, CV scan electroplating, constant current density electroplating, and constant potential electroplating for the catalyst deposition. Hence, co-electroplated IrRuOₓ-based catalysts with high activity and good stability can be achieved based on the above strategies. As shown in the SEM images in FIG. 22, the co-electroplated IrRuOₓ catalysts via a pulse co-electroplating method are uniformly deposited on the TTLGDL substrate (pore size of ˜200 μm and porosity of ˜40%) with good surface coverage, showing in good nanoparticle structures. And the particle size (e.g., having sizes in a range from about 20 nm to about 500 nm) and catalyst loading can be well-tuned by changing the co-electroplating time and conditions. In some embodiments, with longer co-electroplating time, higher catalyst loadings can be obtained, and larger particle sizes can be expected since the electroplated catalyst can agglomerate with higher catalyst loadings. In addition, with higher applied current densities, faster electroplating rates can be achieved, and larger particle sizes can be expected. In some embodiments, such a reaction can be performed at ambient pressure. The SEM-EDX mapping results in FIGS. 23A-23E verify that iridium and ruthenium elements are uniformly distributed in the catalyst layer and the element of oxygen is also observed, which further demonstrates the successful and uniform deposition of IrRuOₓ catalysts with good surface coverage on the titanium substrate.

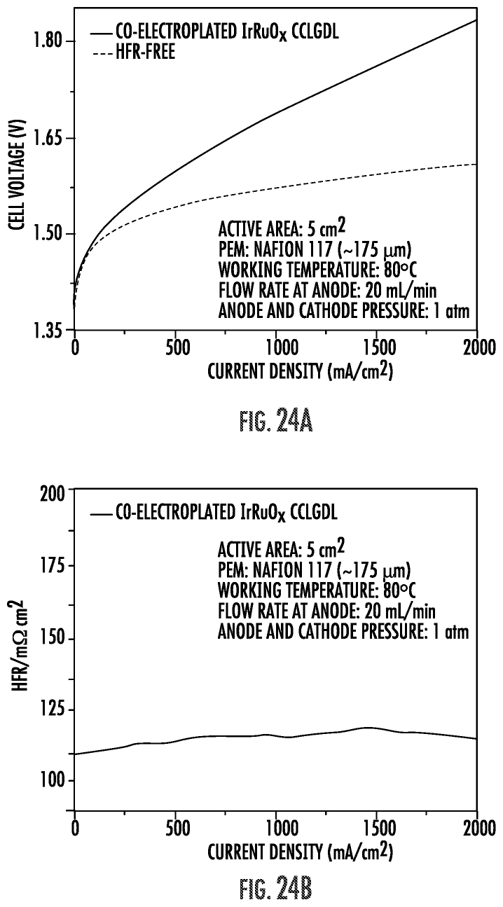

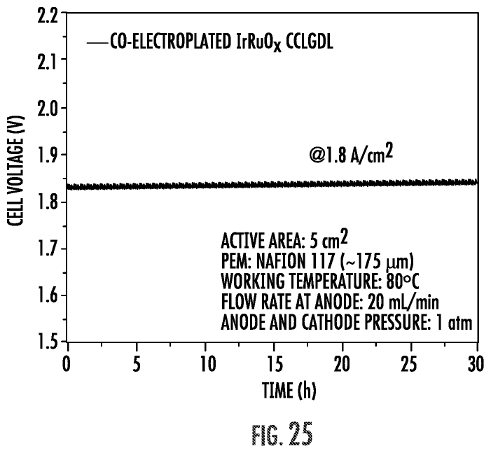

In some embodiments, the co-electroplated IrRuOₓ CCLGDL is applied to a PEMEC by combining with a NAFION™117 membrane (used as a representative, non-limiting example), and the cell performance outperforms the reported anode electrodes in most studies. As shown in FIG. 24A, to drive a high current density of 2 A/cm², the co-electroplated IrRuOₓ CCLGDL achieves a low cell voltage of 1.83 V. And a low cell voltage of 1.61 V is also demonstrated at the current density of 2 A/cm² for the HFR-free performance based on the HFR plot (e.g., having an average value of about 111 mΩ cm²) in FIG. 24B. These performances are superior to anode electrodes for the PEMEC so far. Moreover, as shown in FIG. 25, when the stability of the co-electroplated IrRuOₓ CCLGDL was evaluated at a high current density of 1.8 A/cm² for 30 hours, almost no performance loss was observed. Notably, the fabrication of co-electroplated IrRuOₓ-based electrodes with higher activity and better stability are expected by tuning the atomic ratio and chemical state of the two elements via changing the precursor ratios and electroplating methods.

In addition to some of the benefits discussed above, a co-electroplated IrRuOₓ catalyst-coated liquid/gas diffusion electrode design can provide additional advantages compared with previously reported anode electrodes for the PEMEC. In some embodiments, the atomic ratio of the co-electroplated iridium and ruthenium can be well modulated by controlling the iridium and ruthenium precursor concentrations in the electrolyte and a desirable iridium and ruthenium atomic ratio (e.g., about 7:3) with high intrinsic activity and good stability can be achieved. In addition, in some embodiments, the chemical state and composition of the co-electroplated iridium and ruthenium can be effectively engineered by applying different electroplating methods, such as pulse electroplating, pulse reverse electroplating, CV scan electroplating, constant current density electroplating, and constant potential electroplating. Compared to pure iridium-based catalysts, in some embodiments, the co-electroplated IrRuOₓ catalysts can show lower cost since the ruthenium is cheaper but exhibits superior activity, which can significantly accelerate the commercialization of the PEM electrolyzer. Further, as with the other electrode configurations discussed herein, the co-electroplating of IrRuOₓ CCLGDL is ionomer-free, which can avoid ionomer degradation, mitigate the stability issue, and reduce the ohmic resistance. In other embodiments, the electrode assemblies disclosed herein can be directly used in liquid electrolyte systems. The liquid electrolytes (e.g., H₂SO₄, KOH, NaOH, etc.) with a representative concentration range of about 0.1 M˜1 M can be employed for various electrochemical device applications such as acidic or alkaline water electrolyzers, fuel cells, CO₂/N₂ electrolyzers and so forth.

### PGM-Free Catalysts

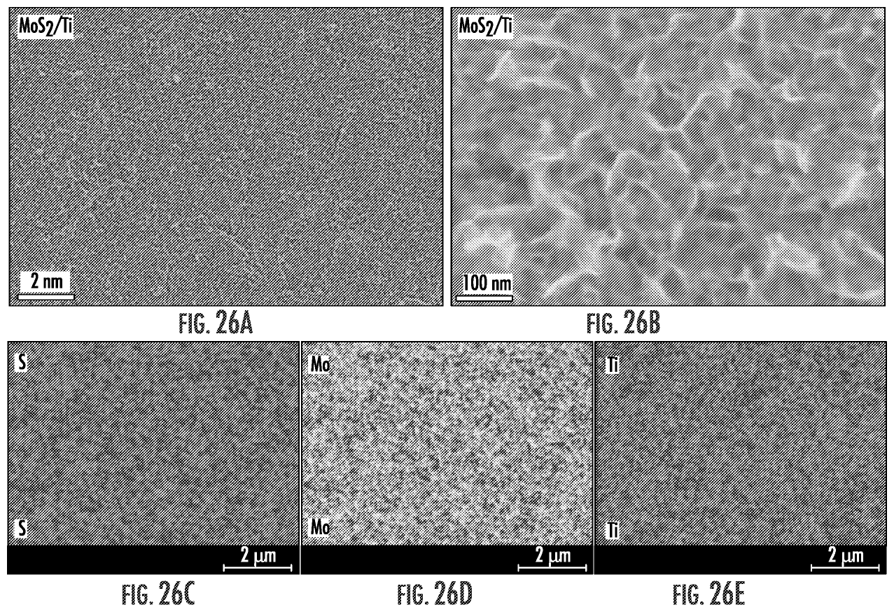

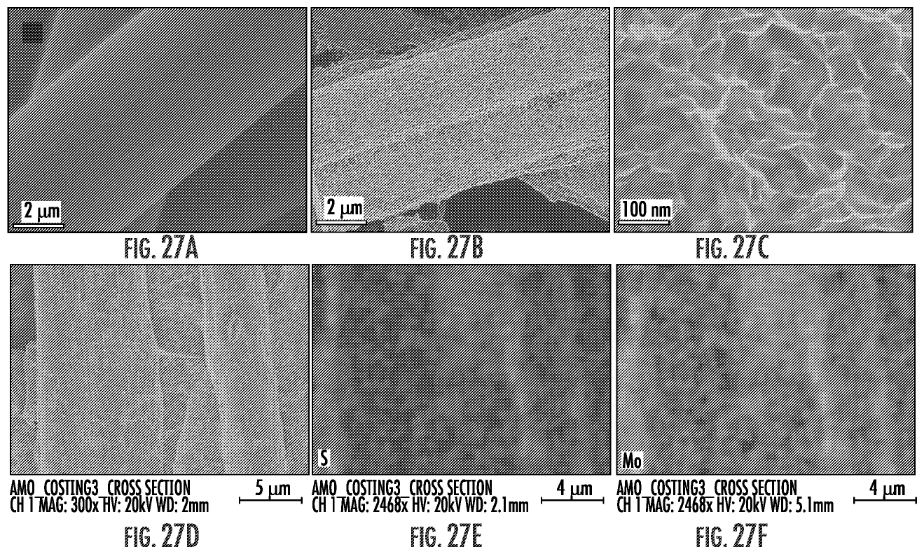

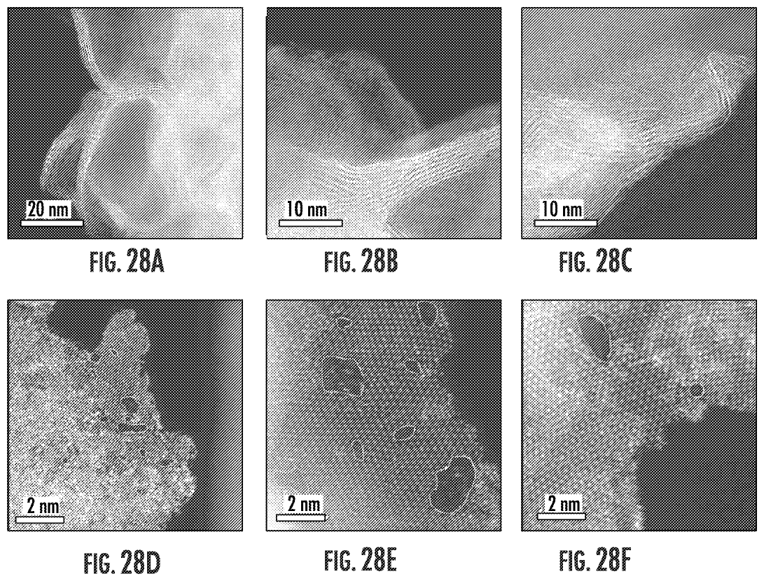

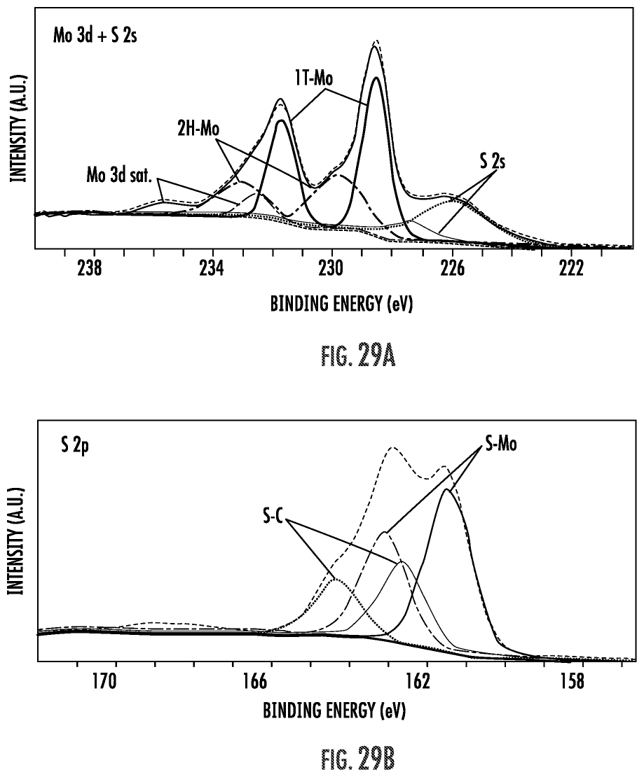

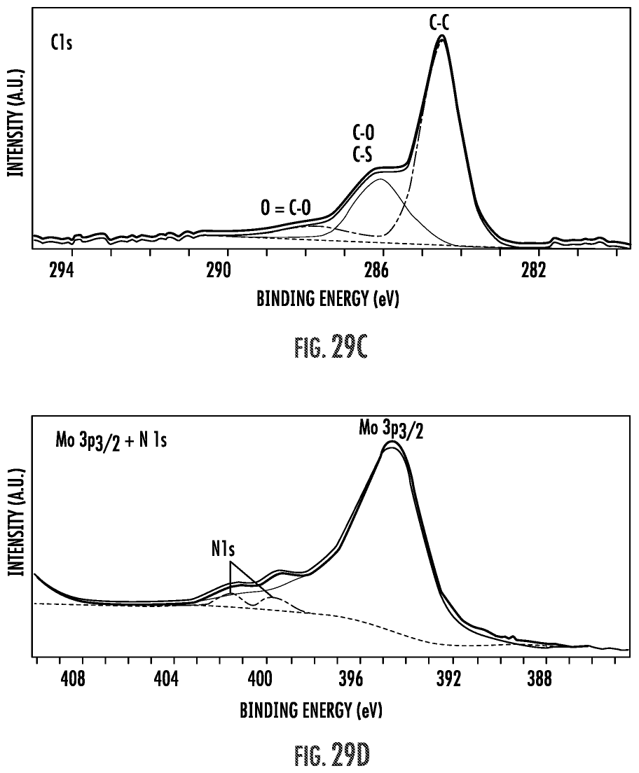

In a further embodiment, an ionomer-free electrolyzer electrode can be produced without any platinum group metal (PGM) catalyst. For example, in some embodiments, a nanoengineered MoS₂ nanosheet-coated metallic titanium substrate (nanoengineered MoS₂NS/Ti) can be fabricated using a one-step scalable hydrothermal method, which can lead to significantly boosted intrinsic activity and electrode robustness. In particular, the electrolyzer electrode can be produced in an autogenous pressure and high-temperature (e.g., ranging from about 200° C. and about 250° C., including about 200° C., 210° C., 220° C., 230° C., 240° C., or 250° C.) environment, such as by placing the substrate into a reaction solution in an autoclave reactor and heating the substrate to a target temperature. In some embodiments, the electrode comprising MoS₂ catalysts is considered complete after approximately 24 hours. Producing the electrolyzer electrode under these conditions can result in desirable crystalline structure (e.g., with edge defects, nanoscale pinholes having sizes of about 1-2 nm, and/or atomic vacancies co-existing on the basal plane of MoS₂ nanosheets as shown in FIGS. 28A-28F), morphologies (e.g., vertically aligned ultrathin nanosheets shown in FIGS. 26A-26E and 27A-27F), and compositions (e.g., 1T-2H heterophase structure and predominant 1T phase in phase composition as shown in FIGS. 29A-29D).

Using such a process, as shown in FIGS. 26A-26E, ultrathin MoS₂ nanosheets with abundant exposed edges can be grown onto a titanium substrate with good uniformity and full surface coverage and without formation of large flower-like assemblies. The synthesis method disclosed herein can also be extended to other metallic substrates (e.g., gold, tungsten, nickel) with either flat surfaces or 3D rough surfaces. The loading and thickness of MoS₂ nanosheets can be well controlled by tuning the reaction time and precursor concentration in the synthesis. For the hydrothermal synthesis method, regardless of materials, the loading/thickness of as-synthesized materials can be generally adjusted by either varying the reaction time or precursor concentration. For example, under the reaction proceeding period with sufficient reactant supplies, extending the reaction time enables the continuous growth of individual nanosheets into the nanosheets with larger lateral size and multi-layer oriented staking, thereby leading to the simultaneous increase of loading and thickness of MoS₂ nanosheets during the synthesis. In addition, with the same reaction time, increasing the precursor concentrations can give rise to more reactant supplies for continuous growth of individual nanosheets into the nanosheets with larger lateral size and multi-layer oriented staking, thereby leading to the simultaneous increase of loading and thickness of MoS₂ nanosheets during the synthesis. More importantly, abundant defects and incorporation of metallic phase can be achieved through such a facile one-step synthesis process by simply tuning the precursor concentrations, solvents, and reaction temperatures. For example, in some embodiments, the precursor has a concentration of sodium molybdate dihydrate as Mo precursor in a range from about 0.01 mol/L to about 0.25 mol/L, and/or a concentration of Thioacetamide as S precursor in a range from about 0.06 mol/L to about 1.6 mol/L. Further in some embodiments, a reaction temperature can be in a range from about 200° C. to about 250° C. Solvents used for such reactions can include deionized water, ethanol, isopropanol, polyethylene glycol, dimethylformamide (DMF), or a combination thereof.

In some embodiments, the growth of such ultrathin MoS₂ nanosheets with abundant defects and desirable phase composition onto carbonaceous substrates is achieved in a one-step scalable hydrothermal method. As shown in FIGS. 27A-27F, SEM and EDX mapping characterizations confirm that ultrathin MoS₂ nanosheets can be in-situ grown onto a commercial carbon fiber paper (CFP) substrate (nanoengineered MoS₂NS/CFP) with very good uniformity and full surface coverage. Highly distorted edges such as folds, sharp vertices and propagating ridges are all identified within different MoS₂ nanosheets, as seen from the HAADF-STEM images in FIGS. 28A-28F. In this regard, desirable nanoscale pinholes (e.g., having sizes of about 1-2 nm) and atomic vacancies co-exist on the basal plane.

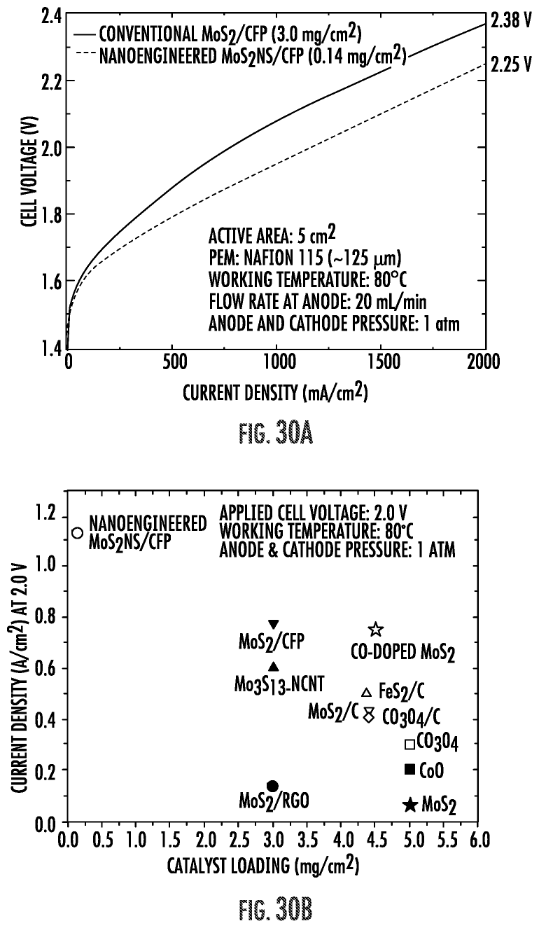

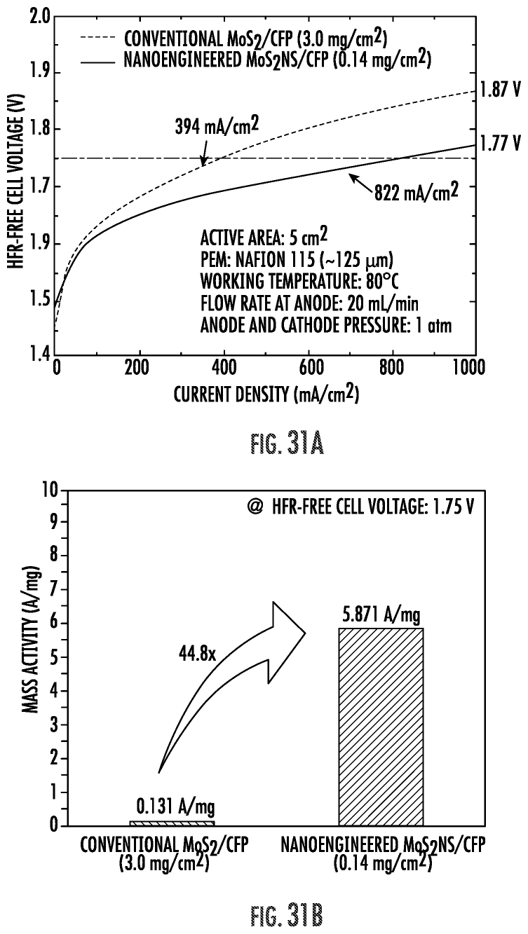

In one example application in a PEMEC, as seen in FIG. 30A, when operating at 2000 mA/cm², nanoengineered MoS₂NS/CFP with an ultralow loading of about 0.1 mg/cm² to about 0.3 mg/cm², including about 0.14 mg/cm² as a particular example, demonstrates a much lower cell voltage of 2.25 V compared to that of conventional MoS₂/CFP (2.38 V). This excellent cell performance outperforms previously reported PGM-free HER catalysts in a PEMEC under the same operation conditions, as compared in FIG. 30B. Moreover, nanoengineered MoS₂NS/CFP has about 20-40 times lower catalyst loadings compared to all previously reported loadings in a PEMEC. The HFR-free polarization curves in FIG. 31A further identify that the activation losses of nanoengineered MoS₂NS/CFP electrode is significantly lower than conventional MoS₂/CFP, as evidenced by the decrease of overpotential by 100 mV at 1000 mA/cm². These results validate that nanoengineered MoS₂NS/CFP possesses greatly increased reaction sites and improved the electrode electrical conductivity. By calculation of mass activities at HFR-free cell voltage of 1.75 V, FIG. 31B shows that the mass activity of nanoengineered MoS2NS/CFP is as high as 5.871 A/mg, which is over 44.8 times higher than that of a conventional MoS₂/CFP. The overpotential and mass activity can work as two good indicators for comparing the number of active sites and catalytic activities for catalysts. In general, a smaller overpotential of nanoengineered MoS₂NS/CFP indicates more reaction sites in the catalysts than a conventional MoS₂/CFP. FIG. 31B shows that the mass activity of nanoengineered MoS₂NS/CFP is as high as 5.871 A/mg, which is over 44.8 times higher than that of a conventional MoS₂/CFP, indicating increased reaction sites. In other embodiments, the electrode assemblies disclosed herein can be directly used in liquid electrolyte systems. The liquid electrolytes (e.g., H₂SO₄, KOH, NaOH, etc.) with a representative concentration range of about 0.1 M˜1 M can be employed for various electrochemical device applications such as acidic or alkaline water electrolyzers, fuel cells, CO₂/N₂ electrolyzers and so forth.

### Dual CCLGDL MEA Fabrication Strategy

In some embodiments, the prepared first and second CCLGDL 121 and 122 can be applied at both an anode side and a cathode side of solid polymer electrolyte electrolyzers and other electrochemical cells simultaneously, rather than separately. Such a dual CCLGDL MEA fabrication strategy avoids the complex fabrication of conventional ionomer-included CL compared with the anode or cathode only CCLGDL configuration and full CCM configuration. Moreover, in some embodiments, the first and second CCLGDL 121 and 122 can be directly assembled together with the solid polymer electrolyte membrane 110, such as PEM or anion exchange membrane (AEM), and no additional processes are needed for the assembly.

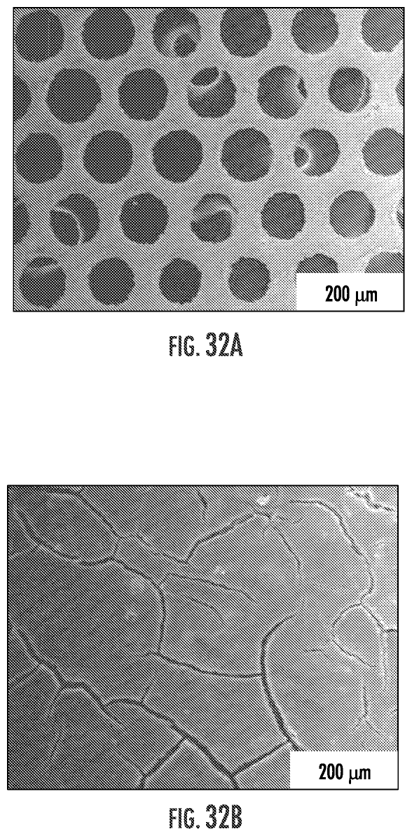

Generally, various LGDLs could be applied as the anode CCLGDL substrates, such as the TTLGDL, Ti felt, or Ti foam, and other metallic substrates, and the anode CCLGDL substrates can include one or more porous and/or nonporous material layers. In some embodiments, the anode CCLGDL substrates can have a thickness in a range of about 25 μm to about 500 μm. Further, in some embodiments, the anode CCLGDL substrates can have a plurality of pores each having a hydraulic diameter in a range of about 25 μm to about 400 μm and a porosity of about 20% to about 70%. In addition, a surface of the anode CCLGDL substrates can be modified according to any of a variety of methods to reduce electrical resistance of the substrate, reduce an interfacial contact resistance, improve activity of the catalyst, increase a surface area of the substrate, and combinations thereof. As discussed above, example modifications include but not limited to forming a surface coating on the substrate (e.g., a nitride, a metal, a carbide, a composite, and combinations thereof), treating the substrate with hydrochloric acid to form pillar-like surface structures, or treating the substrate with oxalic acid to form smooth surface structures that reduce an interfacial contact resistance of the substrate. Likewise, any of a variety of catalysts can be selected for the anode. All the OER catalysts mentioned above could be applied as the anode catalysts, such as catalyst compositions that include Ir, IrOₓ, IrO₂, IrRuOₓ, or other OER catalysts. In a particular embodiment, the anode CCLGDL has a TTLGDL substrate and an electroplated IrOₓ catalyst as shown in FIG. 32A.

Similarly, the configurations of the cathode CCLGDLs are also highly adjustable with various LGDL substrates and HER catalysts. Typically, a micro porous layer on the cathode LGDL substrate is needed for better reaction area management. Cathode CCLGDL substrates can further include one or more further porous and/or nonporous material layers. In some embodiments, the cathode CCLGDL substrates can have a thickness in a range of about 25 μm to about 500 μm. Further, in some embodiments, the cathode CCLGDL substrates can have a plurality of pores each having a hydraulic diameter in a range of about 25 μm to about 400 μm and a porosity of about 20% to about 70%. In addition, a surface of the cathode CCLGDL substrates can be modified according to any of a variety of methods discussed above, including but not limited to forming a surface coating on the substrate (e.g., a nitride, a metal, a carbide, a composite, and combinations thereof), treating the substrate with hydrochloric acid to form pillar-like surface structures, or treating the substrate with oxalic acid to form smooth surface structures that reduce an interfacial contact resistance of the substrate.

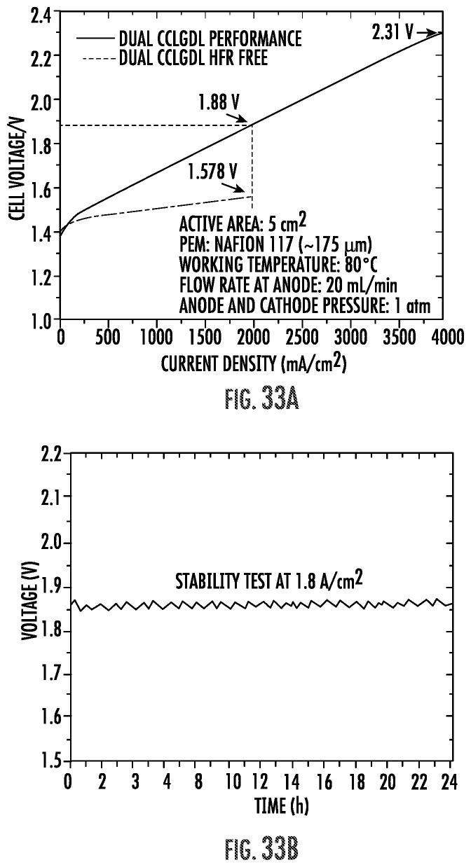

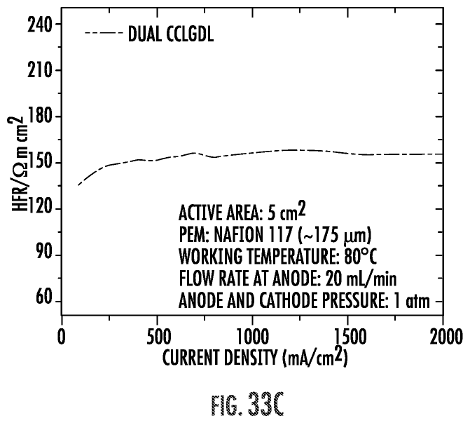

A particular cathode CCLGDL morphology is show in FIG. 32B. The feasibility of this typical integrated electrode design was in-situ validated in a practical PEMEC. The cell performance is shown in FIG. 33A. In this example configuration, the performance test was conducted at a temperature of 80° C., and water flow rate of 20 mL/min at the anode side with a NAFION™117 membrane (used as a representative, non-limiting example). Both anode and cathode sides share the same ambient pressure. The anode and cathode catalyst loadings are 0.32 mg_{IrOx}/cm² and 0.06 mg_{Pt}/cm², respectively. With this dual CCLGDL MEA design strategy and low catalyst loadings, the cell can achieve low cell voltages of 1.88 V and 2.31 V at 2 A/cm² and 4 A/cm², respectively. The HFR-free performance of 1.57 V at 2 A/cm² shows that the catalyst was well utilized in this design. By tuning LGDL pore morphologies (pore size, porosity. etc) and optimizing catalysts (compositions and morphologies), the performance could be further improved with lower catalyst loading. The stability of dual CCLDGL is also validated, as shown in FIG. 33B. The high frequency resistance (HFR) is about 156 mΩ·cm² at 2 A/cm², as shown in FIG. 33C. Compared with the reported performance of conventional CCM design under the same test conditions, the competitive cell performance validates the feasibility of this integrated electrode design. Moreover, considering its simple, scalable and low-cost fabrication compared with the conventional CCM design, the integrated electrode design can not only contribute greatly to reduce the fabrication cost of solid polymer electrolyte electrolyzers and boost the large-scale green hydrogen production but also show great potential applications in fuel cells, unitized regenerative fuel cells (URFCs), sensors and other electrochemical energy devices.

In some embodiments, one or both of a first liquid/gas diffusion layer or a second liquid/gas diffusion layer comprises one or more titanium liquid/gas diffusion layer having a titanium nitride surface coating. However, any other metal-made or carbon-made liquid/gas diffusion layer as would be apparent to one of ordinary skill in the art upon a review of the instant disclosure can be employed, including but not limited to metal-based (e.g., titanium, nickel, stainless steel, niobium) or carbon-based or composite patterned porous sheets (e.g., TTLGDLs, perforated sheets or expanded sheets), papers, felts, cloths, powders, foams, expanded meshes, woven meshes, or combination thereof.

Representative catalyst materials for the catalyst layers disclosed herein include but are not limited to MnᵤSbᵥO_{w}, IrO₂, RuO₂, FeNi oxyhydroxide, Fe lanthanates, inorganic perovskites, Pt, NiMo, NiCo, CoP₂, FeP₂, MoS₂, MoPS, and molecular electrocatalysts such as Co(II) complexes with macrocyclic ligands, Fe(II) complexes with macrocyclic ligands, and Fe—S complexes that resemble metalloenzymes such as nitrogenase or hydrogenase. Catalyst layers can also comprise one or more additional components selected from the group comprising binders, polymers, membranes, electrical conductors, ionic conductors, solid electrolytes, porous materials, inert support materials, metals, semimetals, 2-dimensional materials, porous 3-dimensional materials, nanoparticles, nanosheets, foams, and fibers. Published U.S. Patent Application No. 2022/006407 A1 to Lewis, published Mar. 3, 2022, is hereby incorporated by reference in its entirety.

Although many of the embodiments and examples of the presently disclosed subject matter discussed herein have incorporated a thin tunable layer/gas diffusion layer, those having ordinary skill in the art will recognize that the described electrode configurations and methods can be extended to other substrates, including but not limited to thin/well-tunable titanium substrates, thick titanium substrates (e.g., titanium felt, titanium foam, titanium mesh, etc.), other metallic substrates, carbon paper, or carbon cloth. Furthermore, although the presently-disclosed subject matter has focused on the use of the disclosed electrode configurations in a PEMEC, those having ordinary skill in the art will recognize that the electrode designs and synthesis methods disclosed herein can also be easily extended to other solid polymer electrolyte electrolyzers such as anion exchange membrane electrolyzer cell (AEMEC) and potential applications in fuel cells, unitized regenerative fuel cells (URFCs), sensors and other electrochemical energy devices.

Following long-standing patent law convention, the terms “a”, “an”, and “the” refer to “one or more” when used in this application, including the claims. Thus, for example, reference to “a cell” includes a plurality of such cells, and so forth.

Unless otherwise indicated, all numbers expressing quantities of ingredients, properties such as reaction conditions, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

Likewise, the presently disclosed subject matter can be embodied in other forms without departure from the spirit and essential characteristics thereof. The embodiments described therefore are to be considered in all respects as illustrative and not restrictive. Although the presently disclosed subject matter has been described in terms of certain preferred embodiments, other embodiments that are apparent to those of ordinary skill in the art are also within the scope of the presently-disclosed subject matter.

1. An electrode for a solid or liquid electrolyte electrode assembly, the electrode comprising:
a substrate comprising one or more porous material layer; and
an ionomer-free catalyst coated on the substrate, wherein the ionomer-free catalyst comprises an electroplated iridium nanosheet that is coated on the substrate.

2. The electrode of claim 1, wherein the substrate further comprises one or more nonporous material layer.

3. The electrode of claim 1, wherein the one or more porous material layer comprises one or more liquid/gas diffusion layer having a thickness in a range of about 25 μm to about 500 μm.

4. The electrode of claim 3, wherein the one or more liquid/gas diffusion layer comprises a titanium liquid/gas diffusion layer having a thickness in a range of about 25 μm to about 200 μm.

5. The electrode of claim 3, wherein the one or more liquid/gas diffusion layer comprises a plurality of pores each having a hydraulic diameter in a range of about 25 μm to about 400 μm and a porosity of about 20% to about 70%.

6. The electrode of claim 1, wherein the one or more porous material layer comprises one or more metal-based or carbon-based or composite liquid/gas diffusion layer selected from the group consisting of a patterned porous sheet, a felt, a cloth, a powder, a mesh, a foam, a paper, and combinations thereof.

7. The electrode of claim 1, wherein the one or more porous material layer comprises a surface coating selected from the group consisting of a nitride, a metal, a carbide, a composite, and combinations thereof.

8.-15. (canceled)

16. A solid polymer electrolyte electrode assembly comprising:
a solid polymer electrolyte membrane;
a liquid/gas diffusion layer arranged on one side of the solid polymer electrolyte membrane; and
an ionomer-free catalyst coated on the liquid/gas diffusion layer, wherein the ionomer-free catalyst comprises an electroplated iridium nanosheet.

17. A method for fabricating a solid polymer electrolyte electrode assembly, the method comprising:
providing a substrate comprising one or more porous material layer;
coating an ionomer-free catalyst on the substrate, wherein the ionomer-free catalyst comprises an electroplated iridium nanosheet that is coated on the substrate; and
coupling the substrate to a solid polymer electrolyte membrane.

18. The method of claim 17, wherein providing the substrate comprises modifying a surface of the porous substrate to reduce electrical resistance of the substrate, to improve catalyst activity, and combinations thereof.

19. The method of claim 18, wherein modifying the surface of the substrate comprises forming a surface coating on the substrate, the surface coating being selected from the group consisting of a nitride, a metal, a carbide, a composite, and combinations thereof that reduce an interfacial contact resistance, improve catalyst activity, and combinations thereof.

20. The method of claim 18, wherein modifying the surface of the substrate comprises treating the substrate with hydrochloric acid to form pillar-like surface structures that reduce an interfacial contact resistance and increase a surface area of the substrate.

21. The method of claim 18, wherein modifying the surface of the substrate comprises treating the substrate with oxalic acid to form smooth surface structures that reduce an interfacial contact resistance of the substrate.

22.-23. (canceled)

24. The method of claim 17, wherein coating a catalyst on the substrate comprises selectively electroplating an iridium nanosheet on the substrate at a temperature in a range of about 80° C. to about 90° C. and ambient pressure.

25.-28. (canceled)

29. The method of claim 17, wherein the substrate further comprises one or more nonporous material layer.

30. A dual electrode assembly for a solid polymer electrolyte device comprising:
a solid polymer electrolyte membrane;
a first substrate arranged on a first side of the solid polymer electrolyte membrane;
a second substrate arranged on a second side of the solid polymer electrolyte membrane substantially opposing the first side;
an ionomer-free anode catalyst coated on the first substrate, wherein the ionomer-free anode catalyst comprises an iridium nanosheet catalyst layer that is electroplated on the first substrate; and
an ionomer-free cathode catalyst coated on the second substrate.

31. The dual electrode assembly of claim 30, wherein one or both of the first substrate or the second substrate comprises one or more liquid/gas diffusion layer having a thickness in a range of about 25 μm to about 500 μm.

32. The dual electrode assembly of claim 30, wherein one or both of the first substrate or the second substrate comprises one or more metal-based or carbon-based or composite liquid/gas diffusion layer selected from the group consisting of a patterned porous sheet, a felt, a cloth, a powder, a mesh, a foam, a paper, and combinations thereof.

33. The dual electrode assembly of claim 30, wherein one or both of the first substrate or the second substrate comprises a surface coating selected from the group consisting of a nitride, a metal, a carbide, a composite, and combinations thereof.

34.-38. (canceled)

39. The dual electrode assembly of claim 30, wherein the ionomer-free cathode catalyst comprises a platinum nanosheet grown or electroplated on the second substrate.

40. The dual electrode assembly of claim 30, wherein the ionomer-free cathode catalyst comprises a MoS₂ nanosheet grown on the second substrate.
